(19) United States
(12) Patent Application Publication
(10) Pub. No.: US 2010/0130134 A1
(43) Pub. Date: May 27, 2010

(54) NONLINEAR DISTORTION COMPENSATING APPARATUS AND METHOD

(75) Inventors: Toshio Tamura, Kumagaya (JP); Shigemi Aizawa, Kumagaya (JP); Hiroyuki Takagi, Kumagaya (JP); Taizou Kanou, Kumagaya (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/622,726

(22) Filed: Nov. 20, 2009

(30) Foreign Application Priority Data
Nov. 25, 2008 (JP) 2008-299602

(51) Int. Cl. H04B 1/00

(52) U.S. Cl. 455/63.1

(57) ABSTRACT

A nonlinear distortion compensating apparatus includes a distortion detector configured to detect nonlinear distortion by reproducing a reception signal and output information on the detected nonlinear distortion as control information to a distortion compensating unit which compensates for the nonlinear distortion and which is included in a transmitter.

### CROSS-REFERENCE TO RELATED APPLICATIONS

This application is based upon and claims the benefit of priority of prior Japanese Patent Application No. 2008-299602, filed on Nov. 25, 2008, the entire contents of which are incorporated herein by reference.

### FIELD

Certain aspects of the present invention discussed herein are related to a nonlinear distortion compensating apparatus and compensating method.

### BACKGROUND

In general wireless communication apparatuses, high transmission power attains high communication quality. However, when output power comes close to saturation power of an amplifying circuit, nonlinear distortion occurs. A wireless communication apparatus, for example, which performs digital wireless communication maps a digital signal on a plurality of certain signal points using a transmitter so as to perform modulation and transmission. Therefore, a technique of compensating for nonlinear distortion when a receiver demodulates the modulated signal or when the transmitter performs the mapping so as to modulate the signal has been developed (for example, Japanese Laid Open Patent Publication Nos. 2004-172921 and 08-163198).

However, a technique of correcting distortion in the related art has following disadvantages. (First Disadvantage) In a method for performing distortion compensation in accordance with a mathematical expression obtained by performing mathematization on an input-output characteristic of an amplifying circuit to be subjected to nonlinear distortion compensation in a transmitter, since a characteristic of the amplifying circuit which is obtained in advance is used, it is difficult to perform appropriate control in accordance with change of a state of the amplifying circuit. (Second Disadvantage) In a method for detecting a difference (deviation) between a position of a signal point which has been amplified by the amplifying circuit and a regular position and correcting the difference, the deviation of the position of the passing signal point represents considerable distortion due to deterioration. Therefore, a period of time in which moving and passing among signal points which exhibits the maximum power is not reflected, and the method is not sufficient for correcting deterioration of spectrum which occurs at a transmission antenna terminal.

(Third Disadvantage) In a method for detecting distortion using a reception signal in a receiver, distortion detection fails due to fading in a wireless transmission path, deterioration of a waveform due to rainfall, superposing of noise, and signal error due to such deterioration of communication quality. (Fourth Disadvantage) If an adaptive distortion compensation circuit, which perform mathematization on the input-output characteristic of the amplifying circuit and which updates coefficients included in the mathematical expression using a distortion compensating device in accordance with the mathematical expression, independently controls the coefficients, complicated control is induced. (Fifth Disadvantage) If a compensating amount at the beginning of control is considerably different from a state of generated distortion, or if a state of generation of the distortion is considerably changed and therefore the state becomes considerably different from the compensating amount, the difference can be made smaller in short time when an amount of change of the compensating amount which is changed by one control update is large. However, control is converged while the amount of change stays large, and operation is not stable in a state in which the difference is small.

### SUMMARY

Accordingly, in an aspect, an object of the invention is to easily control nonlinear distortion compensation, and in another aspect, to control the nonlinear distortion compensation with high accuracy.

According to a certain aspect of the invention, a distortion compensating apparatus includes a distortion detector configured to detect nonlinear distortion by reproducing a reception signal and output information on the detected nonlinear distortion as control information to a distortion compensating unit which compensates for the nonlinear distortion and which is included in a transmitter.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration of a nonlinear distortion compensating apparatus according to a first embodiment;

FIG. 2 illustrates a configuration of a transmitter;

FIG. 3 illustrates a flowchart of processing for controlling distortion compensation according to the first embodiment;

FIG. 4 illustrates a state of conversion performed by a converting unit of an input-output characteristic;

FIG. 5 illustrates a configuration of a nonlinear distortion compensating apparatus according to a second embodiment;

FIG. 6 illustrates an example of an eye pattern representing coordinates of passing signal points on a signal space when a reception signal moves among the signal points;

FIG. 7 illustrates a flowchart of processing for controlling distortion compensation according to the second embodiment;

FIG. 8 illustrates a state of calculation of differences;

FIG. 9 illustrates a configuration of a nonlinear distortion compensating apparatus according to a third embodiment;

FIG. 10 illustrates examples of passing signal points when a reception signal moves among signal points;

FIG. 11 illustrates examples of reception signals detected in various units of the apparatus;

FIG. 12 illustrates a flowchart of processing for controlling distortion compensation according to the third embodiment;

FIG. 13 illustrates a configuration of a nonlinear distortion compensation apparatus according to a fourth embodiment;

FIG. 14 illustrates a flowchart of processing for controlling distortion compensation according to a fourth embodiment;

FIG. 15 illustrates a configuration of a nonlinear distortion compensation apparatus according to a fifth embodiment;

FIG. 16 illustrates a state of movement of specified signal points detected by a specific-signal movement detector;

FIG. 17 illustrates a state of charged power of a reception signal which meets a specific-signal movement condition;

FIG. 18 illustrates a flowchart of processing for controlling distortion compensation according to the fifth embodiment;

FIG. 19 illustrates an example of a timing chart of signals;

FIG. 20 illustrates a timing chart representing a concrete example of determination of movement of specific signals;

FIG. 21 illustrates a configuration of a nonlinear distortion compensation apparatus according to a sixth embodiment;

FIG. 22 illustrates a state of charged power of a reception signal which meets a specific-signal movement condition;

FIG. 23 illustrates switch of a state of detection of movement of specified signal points detected by a specific-signal movement detector;

FIG. 24 illustrates a flowchart of processing for controlling distortion compensation according to the sixth embodiment;

FIG. 25 illustrates a configuration of a nonlinear distortion compensation apparatus according to a seventh embodiment;

FIG. 26 illustrates a flowchart of switching of a specific-signal movement condition;

FIG. 27 illustrates a change of the specific-signal movement condition (in a case of timer operation);

FIG. 28 illustrates a change of the specific-signal movement condition (in a case of control loop monitoring);

FIG. 29 illustrates a configuration of a nonlinear distortion compensation apparatus according to an eighth embodiment;

FIG. 30 illustrates states of detection of movement of specified signal points detected by the specific-signal movement detectors;

FIG. 31 illustrates a flowchart of processing for detecting matching of a specific-signal movement condition;

FIG. 32 illustrates a flowchart of the processing for detecting matching of the specific-signal movement condition;

FIG. 33 illustrates a configuration of a nonlinear distortion compensation apparatus according to a ninth embodiment;

FIG. 34 illustrates a state of detection of movement of specified signal points detected by first and second specific-signal movement detectors.

FIG. 35 illustrates a flowchart of processing for detecting matching of a specific-signal movement condition;

FIG. 36 illustrates a flowchart of the processing for detecting matching of a specific-signal movement condition;

FIG. 37 illustrates a configuration of a nonlinear distortion compensation apparatus according to a tenth embodiment;

FIG. 38 illustrates an example of detection performed by a signal-point error detector;

FIG. 39 illustrates a flowchart of processing for controlling distortion compensation according to the tenth embodiment;

FIG. 40 illustrates a configuration of a nonlinear distortion compensation apparatus according to an eleventh embodiment;

FIG. 41 illustrates an example of detection performed by a reception-level deterioration detector;

FIG. 42 illustrates a flowchart of processing for controlling distortion compensation according to the eleventh embodiment;

FIG. 43 illustrates a configuration of a nonlinear distortion compensation apparatus according to a twelfth embodiment;

FIG. 44 illustrates an example of detection of an error ratio detected by a digital-signal processing unit;

FIG. 45 illustrates a flowchart of processing for controlling distortion compensation according to the twelfth embodiment;

FIG. 46 illustrates a configuration of a nonlinear distortion compensation apparatus according to a thirteenth embodiment;

FIG. 47 illustrates a configuration of a nonlinear distortion compensation apparatus according to a fourteenth embodiment;

FIG. 48 illustrates a configuration of a nonlinear distortion compensation apparatus according to a fifteenth embodiment;

FIG. 49 illustrates a flowchart of processing for controlling distortion compensation according to the fifteenth embodiment;

FIG. 50 illustrates a configuration of a nonlinear distortion compensation apparatus according to a sixteenth embodiment;

FIG. 51 illustrates a flowchart of processing for controlling distortion compensation according to the sixteenth embodiment; and

FIG. 52 illustrates a state of generation of distortion detection results.

### DESCRIPTION OF EMBODIMENTS

Embodiments for carrying out the present invention are described with reference to the drawings.

Nonlinear distortion compensating apparatuses according to the embodiments are basically configured so as to have a control loop in which a compensation signal is generated in accordance with a signal actually received by a receiver and the compensation signal is transmitted to a distortion compensating unit included in a transmitter.

### First Embodiment

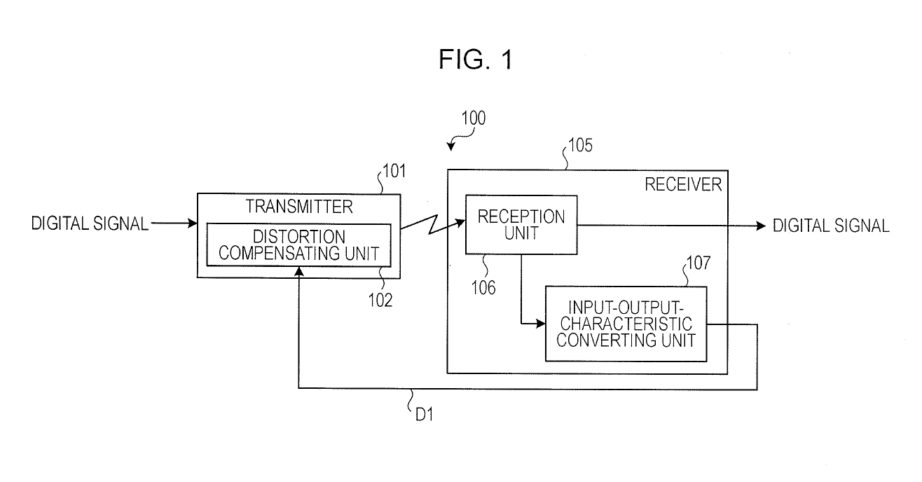

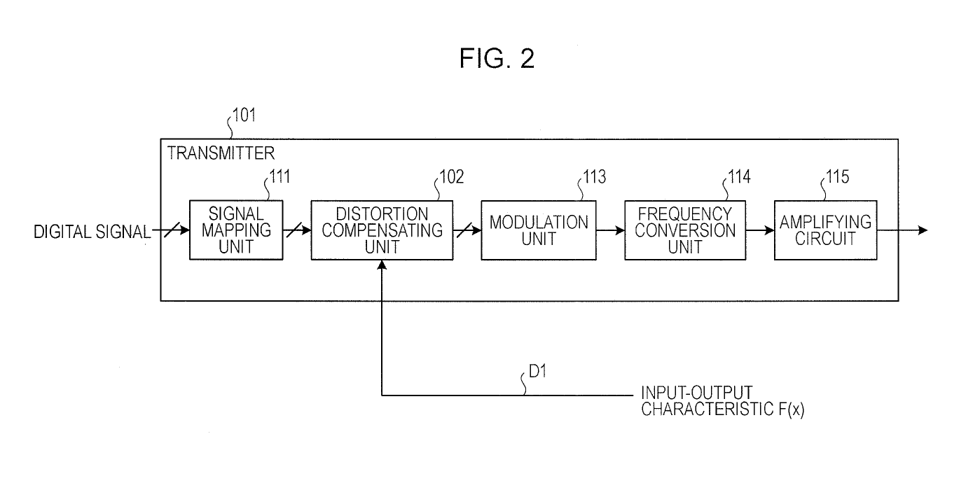

FIG. 1 illustrates a configuration of a nonlinear distortion compensating apparatus 100 according to a first embodiment. The nonlinear distortion compensating apparatus 100 includes a transmitter 101 and a receiver 105. The transmitter 101 includes a distortion compensating unit 102, and the receiver 105 includes a receiving unit 106 and an input-output-characteristic converting unit 107. The converting unit of input-output characteristic 107 detects nonlinear distortion as described below. Furthermore, FIG. 2 illustrates an internal configuration of the transmitter 101. A digital signal is supplied to the transmitter 101, the base-band digital signal is mapped on a plurality of predetermined signal points in an orthogonal signal space which is separated into I and Q by the signal mapping unit 111. The signal subjected to distortion compensation in the distortion compensating unit 102 is further subjected to predetermined linear conversion such as PSK (phase shift keying) and QAM (quadrature amplitude modulation) in a modulation unit 113, is up-converted in a frequency conversion unit 114, is amplified in an amplifying circuit 115, and is transmitted as a wireless signal.

The input-output-characteristic converting unit 107 calculates an input-output characteristic of the amplifying circuit 115 included in the transmitter 101 using the wireless signal received by the receiving unit 106 and a digital signal which has been received and reproduced. Data of the calculated input-output characteristic is transmitted as a compensation signal D1 which is a wireless signal, for example, from the receiver 105 to the distortion compensating unit 102 included in the transmitter 101. The distortion compensating unit 102 included in the transmitter 101 performs distortion compensation in accordance with the data of the input-output characteristic represented by the supplied compensation signal D1 so as to address nonlinearity of amplitude performed by the amplifying circuit 115.

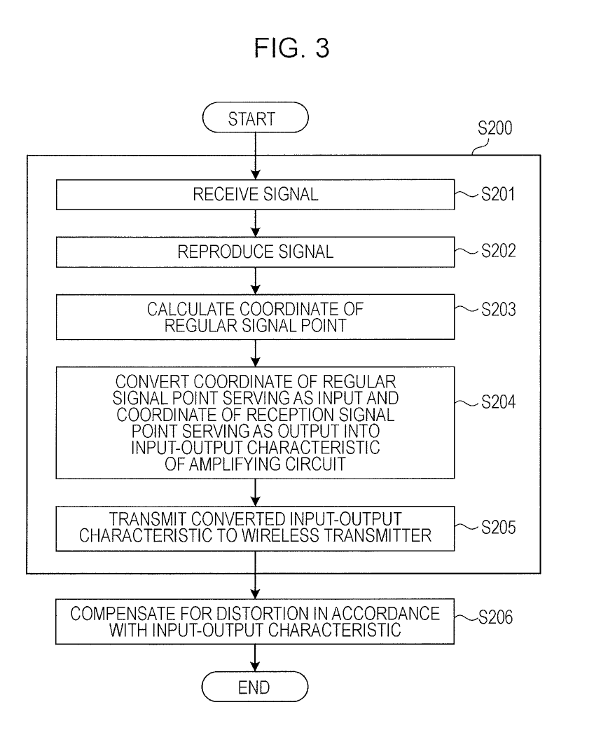

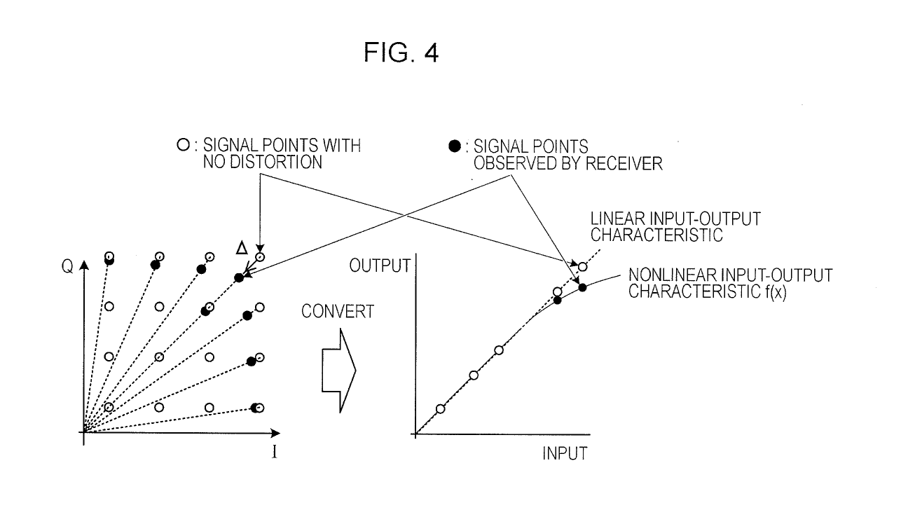

FIG. 3 illustrates a flowchart of processing for controlling the distortion compensation according to the first embodiment. FIG. 4 illustrates a state of conversion performed by the input-output-characteristic converting unit 107. The receiver 105 performs processes included in step S200 of FIG. 3 and the transmitter 101 performs a process in step S206. First, when the transmitter 101 transmits a signal which has not been subjected to distortion compensation, the receiving unit 106 included in the receiver 105 wirelessly receives the signal (in step S201). Then, the reception signal is reproduced (in step S202). Here, regular signal-point coordinates are calculated (in step S203). It is assumed that white circles denote the regular signal-point coordinates, and black circles denote signal-point coordinates detected as reception signals (in a graph on the left side of FIG. 4).

The input-output-characteristic converting unit 107 receives the regular signal-point coordinates and outputs reception-signal-point coordinates so as to convert the regular signal-point coordinates into an input-output characteristic of the amplifying circuit 115 included in the transmitter 101 (in step S204). In FIG. 4, an axis of abscissa denotes an input characteristic and an axis of ordinate denotes an output characteristic (in a graph on the right side of FIG. 4). In an example shown in FIG. 4, signal-point coordinates of 64 QAM are shown. Specifically, the input-output-characteristic converting unit 107 calculates differences Δ between coordinates in the signal space, which are obtained by calculation using a reproduction signal obtained by reproducing the reception signal and which are passed when the reproduced signal moves among signal points and coordinates of the detected reception signals. Then, the obtained differences are converted into an input-output characteristic f(x) which is a certain function normalized by a distance between signal points (Euclidean distance).

Then, data representing the input-output characteristic f(x) is transmitted as a compensation signal D1 to the distortion compensating unit 102 included in the transmitter 101 (in step S205). The distortion compensating unit 102 included in the transmitter 101 performs compensation by cancelling nonlinearity of the data f(x) representing the input-output characteristic (in step S206). For example, the distortion compensating unit 102 performs control in order to transmit a wireless signal having a reverse characteristic of the input-output characteristic f(x) using a linear input-output characteristic shown in FIG. 4 as a reference.

The input-output-characteristic converting unit 107 may constantly or periodically transmit the compensation signal D1. Furthermore, the distortion compensating unit 102 may store the received compensation signal D1 in a storage unit, not shown, so as to use the compensation signal D1 for the distortion compensation described above. In this case, data stored in the storage unit is updated every time the compensation signal D1 is received.

With this configuration, the receiver 105 receives an actual wireless signal and performs mathematization on the input-output characteristic of the amplifying circuit 115 included in the transmitter 101, which is to be subjected to nonlinear distortion compensation. As described above, since a control loop (closed loop) is generated by receiving a signal by the receiver 105 and transmitting the compensation signal D1 used for nonlinear distortion compensation from the receiver 105 to the transmitter 101, change of a state of the amplifying circuit 115, for example, change of temperature or variation of the amplifying circuit 115 may be appropriately compensated for.

### Second Embodiment

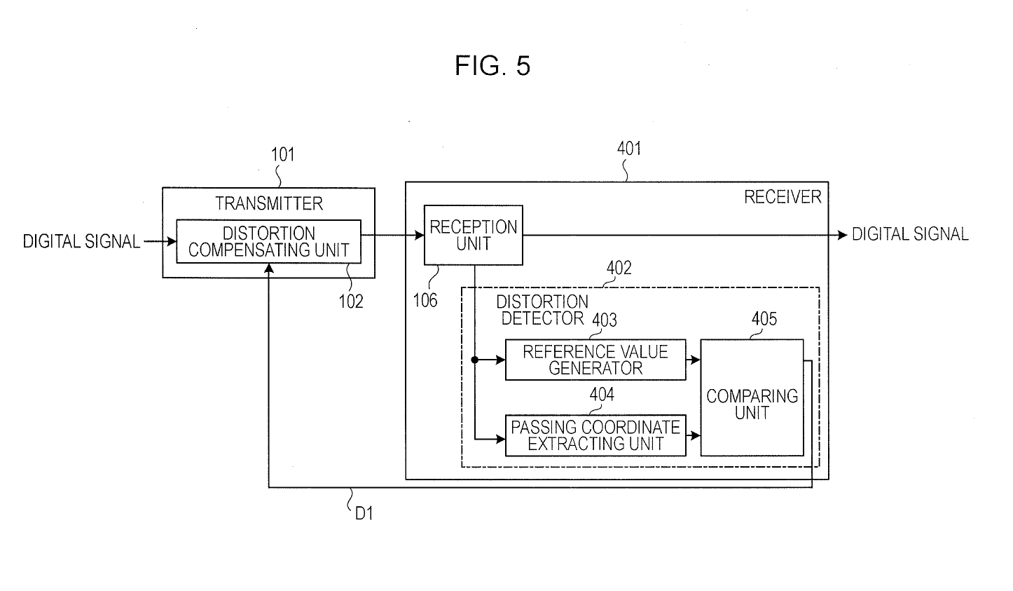

FIG. 5 illustrates a configuration of a nonlinear distortion compensating apparatus according to a second embodiment. A distortion detector 402 included in a receiver 401 according to the second embodiment includes a reference value generator 403 which generates reference coordinates of signal points, a passing coordinate extracting unit 404 which extracts passing coordinates of a detected reception signal, and a comparing unit 405 which compares the reference coordinates of the reference value generator 403 with the passing coordinates.

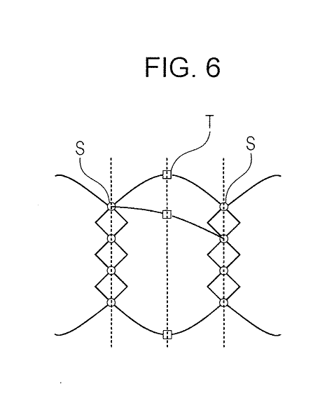

FIG. 6 illustrates an example of an eye pattern representing coordinates of passing signal points in a signal space when a reception signal moves among signal points. An axis of abscissa denotes time and an axis of ordinate denotes amplitude. As shown in FIG. 6, when a reception signal moves among a plurality of signal points S, passing coordinates T are generated. For example, the distortion detector 402 obtains reference coordinates to be passed, which are determined in accordance with the signal points in which the reception signal passes and which are located among the signal points S from the reference value generator 403. Specifically, the reference coordinates are determined by discriminating signals which are synchronously detected by a receiving unit 106 by a discriminating unit, not shown, included in the reference value generator 403, reproducing a digital signal, and obtaining a state of movement among signal points generated by an internal calculation circuit in accordance with the reproduced digital signal.

Furthermore, a passing coordinate detected as a reception signal is obtained from the passing coordinate extracting unit 404. For example, the passing coordinates shown as points T in FIG. 6 correspond to points of maximum power. When distortion occurs, the passing coordinates T of the detected reception signal are deviated relative to positions of the reference coordinates. The comparing unit 405 obtains differences between the reference coordinates and the passing coordinates. The distortion detector 402 transmits data representing the differences as a compensation signal D1 to a distortion compensating unit 102 of a transmitter 101. The distortion compensating unit 102 performs distortion compensation in accordance with the data representing the detected difference.

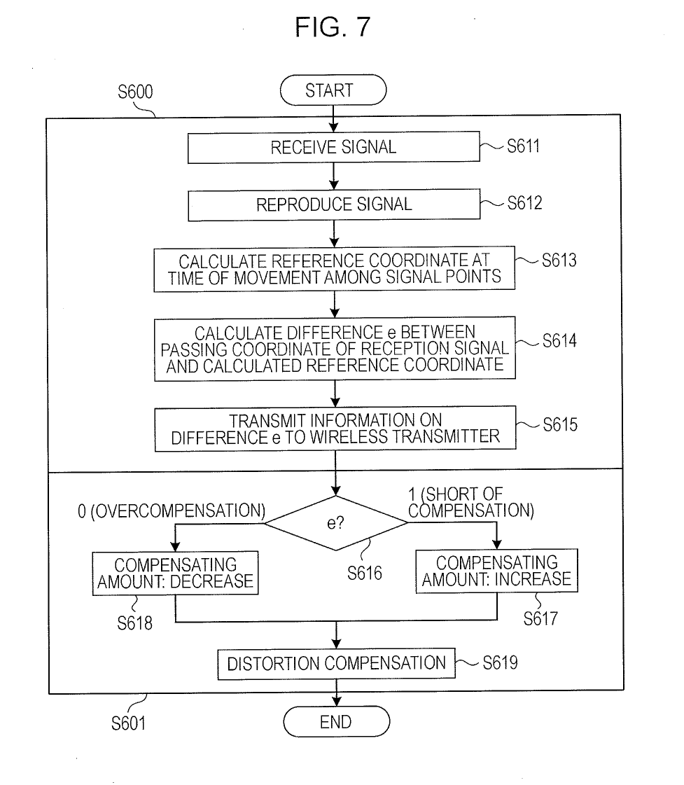

FIG. 7 illustrates a flowchart of processing for controlling distortion compensation according to the second embodiment. In FIG. 7, the receiver 401 performs processes included in step S600 and the transmitter 101 performs processes included in step S601. First, the transmitter 101 transmits a signal which has not been subjected to distortion compensation, and the receiving unit 106 included in the receiver 401 wirelessly receives the signal (in step S611). Then, the reception signal is reproduced (in step S612).

At this time, the reference value generator 403 included in the distortion detector 402 calculates reference coordinates when movement among signal points S is performed (in step S613). Thereafter, the comparing unit 405 included in the distortion detector 402 calculates differences e between passing coordinates obtained by monitoring the reception signal using the passing coordinate extracting unit 404 and the reference coordinates calculated using the reference value generator 403 (in step S614). The distortion detector 402 transmits data representing the differences e to the distortion compensating unit 102 included in the transmitter 101 (in step S615).

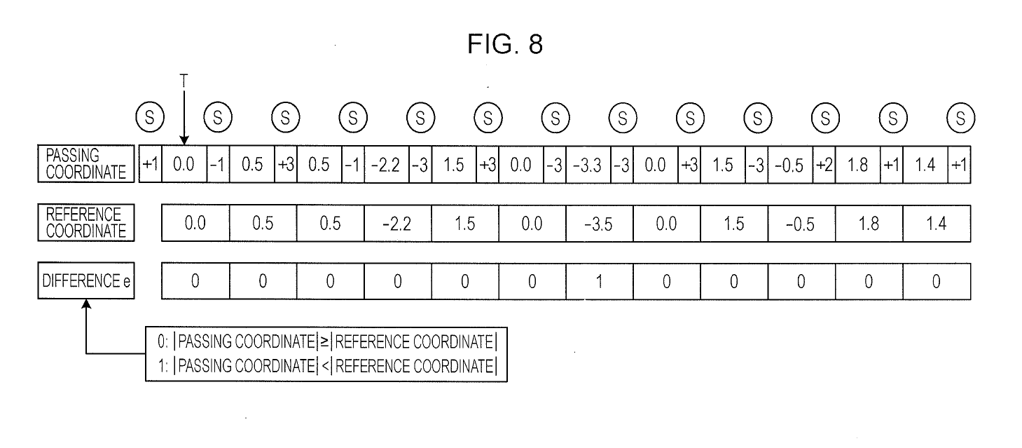

FIG. 8 illustrates a state of calculation of the differences in detail. An axis of abscissa denotes time. Passing coordinates are shown in a top line, S denotes passing coordinates in signal points, and T denotes coordinates (passing coordinates) in movement among the signal points S. Reference coordinates calculated using the reference value generator 403 are shown in a middle line. When |passing coordinate|≦|reference coordinate| is satisfied, data representing 0 is output as the difference e, and |passing coordinate|<|reference coordinate| is satisfied, data representing 1 is output as the difference e.

Referring back to FIG. 7, when receiving the data representing the differences e, the distortion compensating unit 102 included in the transmitter 101 performs distortion compensation in accordance with the data representing the differences e (in step S619). Here, it is determined whether a compensating amount is large or small using the data representing the differences e. When “1” representing shortage of the compensating amount is determined (in step S616:1), the compensating amount is increased (in step S617). On the other hand, when “0” representing overcompensating amount is determined, (in step S616:0), the compensating amount is reduced (in step S618).

With this configuration, the receiver 401 receives an actual wireless signal, detects differences (deviation) between positions of signal points which have been amplified using the amplifying circuit 115 (shown in FIG. 2), which is included in the transmitter 101 and which is an object to be subjected to linear distortion compensation with regular positions, and controls the differences to be compensated for. In this way, the distortion compensation can be performed taking a state of moving and passing between signal points having maximum power into consideration using deviation of positions of passing signal points generated due to considerable distortion of deterioration of the amplifying circuit 115. Accordingly, spectrum deterioration which occurs at an antenna terminal can be compensated for.

### Third Embodiment

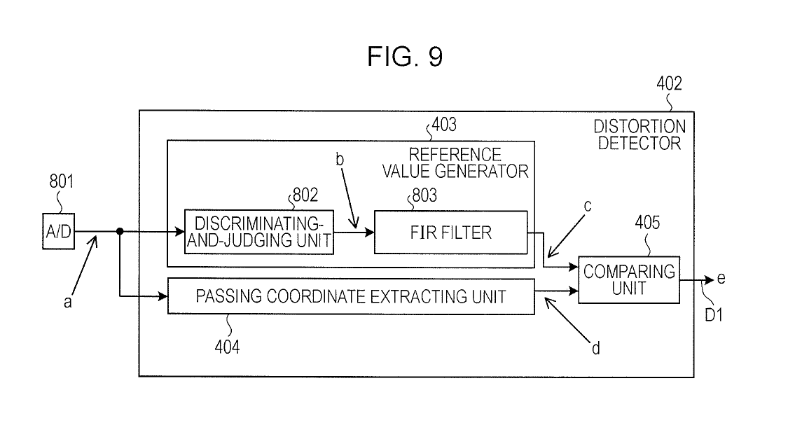

FIG. 9 illustrates a configuration of a nonlinear distortion compensating apparatus according to a third embodiment. In the third embodiment, an internal configuration of a distortion detector 402 which corresponds to that of the second embodiment (FIG. 5) will be described. In the third embodiment, a digital filter (FIR filter) 803 having a function similar to that of a band-limiting filter included in the transmitter 101 is also included in the reference value generator 403 of the receiver 401. Then, a signal reproduced by the receiver 401 is supplied to the digital filter (FIR filter) 803 having the function similar to that of the band-limiting filter used in the transmitter 101, and a signal output from the digital filter is determined as a reference value (a coordinate of a signal to be detected by the receiver 401) of distortion detection. With this reference value, distortion is detected.

In FIG. 9, an A/D converter 801 is included in a receiving unit 106 and converts an analog reception signal into a digital signal. The reference value generator 403 includes a discriminating-and-judging unit 802 and the FIR filter 803. The discriminating-and-judging unit 802 reproduces a transmission signal after performing logical determination on the reception signal which has been subjected to the A/D conversion. The FIR filter 803 has an input-output characteristic the same as that of the band-limiting filter included in the transmitter 101. Furthermore, the passing coordinate extracting unit 404 extracts passing coordinates positioned among signal points. The passing coordinate extracting unit 404 includes a delay unit which delays a signal to be output by a delay time that is the same as processing time of the FIR filter 803 included in the reference value generator 403. A comparing unit 405 compares, as with the second embodiment, reference coordinates with the passing coordinates.

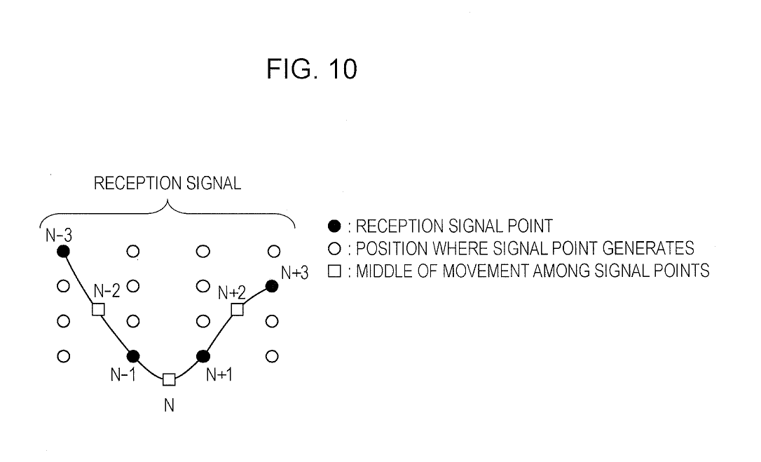

FIG. 10 illustrates examples of passing signal points when a reception signal moves among signal points. An axis of ordinate denotes amplitude, and an axis of abscissa denotes time. Black circles denote reception signal points, white circles denote positions where signal points generate, and white squares denote middle points of the movement among the signal points. As shown in FIG. 10, a signal which has been synchronously detected by the receiver 401 is discriminated using the discriminating-and-judging unit 802 included in the reference value generator 403.

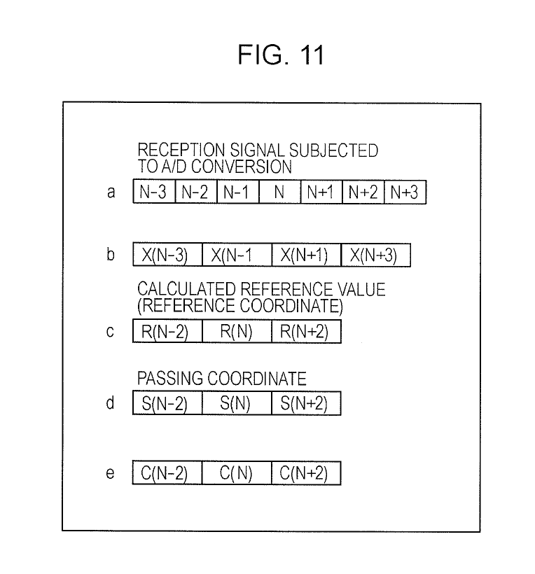

FIG. 11 illustrates examples of reception signals detected in various units included in the apparatus. As a signal a output from the A/D converter 801, a digital signal X(m) [m: N−3, N−2, N−1, N, N+1, N+2, and N+3] is reproduced. As a signal b output from the discriminating-and-judging unit 802, a signal X(m) [m: N−3, N−1, N+1, and N+3] is reproduced. When the reproduced digital signal is supplied to the FIR filter 803 which performs band limitation, as a signal c output from the FIR filter 803, a coordinate R(n) [n: N−2, N, and N+2] which is passed at a time of movement among output signal points is reproduced. The coordinate R(n) which is passed at the time of movement among output signal points is determined as a reference value (reference coordinate).

Furthermore, the passing coordinate extracting unit 404 delays a reception signal by the delay time which is the same as the processing time of the reference value generator 403, and extracts a passing coordinate S(n) [n: N−2, N, and N+2] at a time the signal serving as an output d moves among signals. The comparing unit 405 compares the passing coordinate S(n) with the reference coordinate R(n), and outputs information C(n) [n: N−2, N, and N+2] of a coordinate difference serving as an output e. The difference e includes information on a distortion overcompensating amount and information on shortage of the distortion compensating amount. The distortion detector 402 transmits data of the difference e as a compensation signal D1 to the distortion compensating unit 102 included in the transmitter 101. The distortion compensating unit 102 performs distortion compensation in accordance with distortion using the data of the detected difference e.

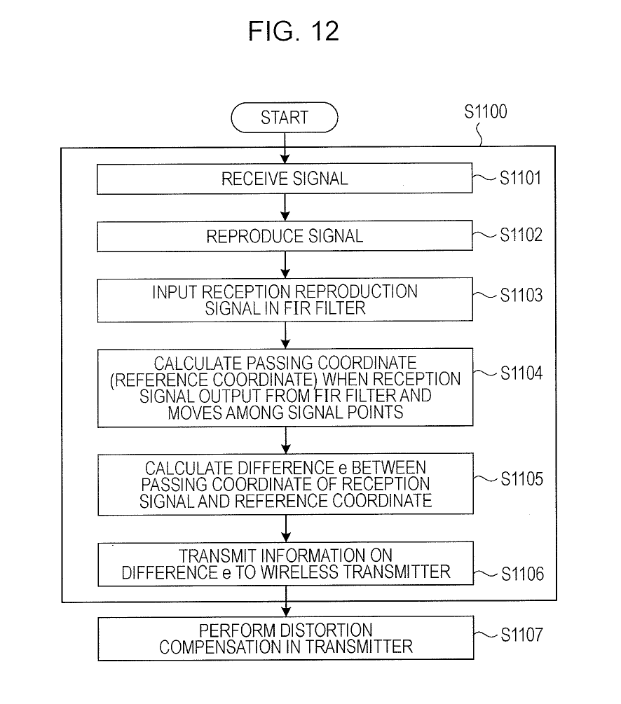

FIG. 12 illustrates a flowchart of processing for controlling distortion compensation according to the third embodiment. The receiver 401 performs processes included in step S1100 shown in FIG. 12, and the transmitter 101 performs a process of step S1107 shown FIG. 12. First, the transmitter 101 transmits a signal which has not been subjected to distortion compensation, and the receiving unit 106 of the receiver 401 wirelessly receives the signal (in step S1101). Next, the reception signal is reproduced (in step S1102).

Then, the reception reproduction signal reproduced by the discriminating-and-judging unit 802 is supplied to the FIR filter 803 having a characteristic the same as that of the band-limiting filter included in the transmitter 101 (in step S1103). By this, passing coordinates at a time of movement among signal points are calculated using a signal output from the FIR filter 803 (in step S1104). The passing coordinates correspond to reference values (reference coordinates). Then, the comparing unit 405 calculates differences e between the reference coordinates and the passing coordinates of the reception signal extracted by the passing coordinate extracting unit 404 (in step S1105). The distortion detector 402 transmits data representing the differences e serving as a compensation signal D1 to the distortion compensating unit 102 included in the transmitter 101 (in step S1106). Then, the distortion compensating unit 102 included in the transmitter 101 performs distortion compensation in accordance with the differences e represented by the supplied compensation signal D1 (in step S1107).

With this configuration, since the FIR filter 803 having a function the same as that of the band-limiting filter is included in the receiver 401, a state in which distortion occurs is detected using the transmitter 101 and the receiver 401, and a signal output from the FIR filter 803 is used as a reference value of the distortion detection. In this way, using deviation of positions of the passing signal points generated in the amplifying circuit 115 due to generation of distortion which has been considerably deteriorated, distortion compensation can be performed taking a state of moving and passing between signal points having maximum power into consideration using the deviation of the positions of the passing signal points generated due to considerable distortion of deterioration of the amplifying circuit 115. Accordingly, spectrum deterioration which occurs at an antenna terminal can be compensated for.

### Fourth Embodiment

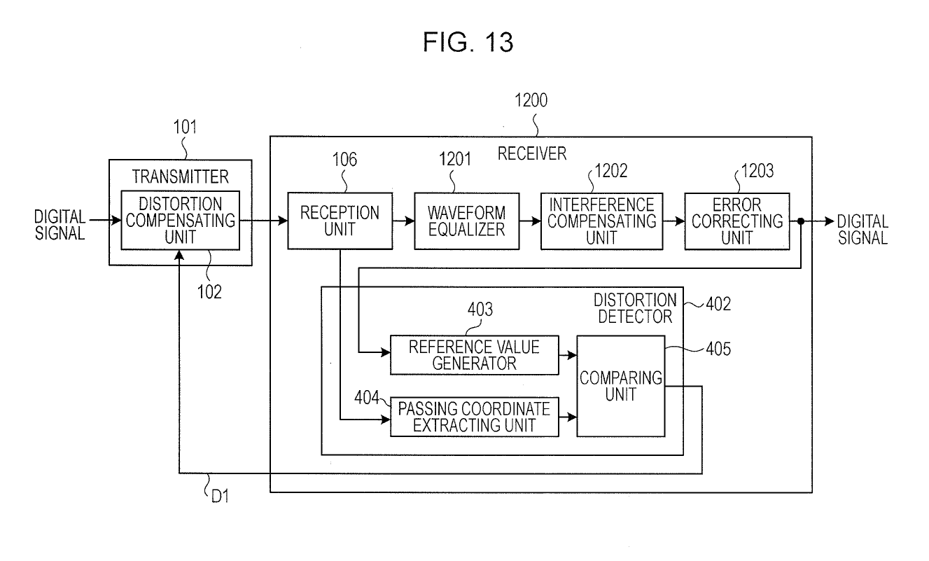

FIG. 13 illustrates a configuration of a nonlinear distortion compensation apparatus according to a fourth embodiment. In the fourth embodiment, a receiver 1200 generates reference values (reference coordinates) used for distortion detection using a reception signal which has been subjected to waveform equalization, interference compensation, and error correction so as to accurately perform the distortion detection taking a characteristic of a wireless transmission path into consideration.

A signal which is synchronously detected by a receiving unit 106 is supplied to a waveform equalizing unit 1201. The waveform equalizing unit 1201 equalizes linear distortion in the wireless transmission path. The waveform equalizing unit 1201 is connected to an interference compensating unit 1202 which compensates for interference of different polarization and the interference compensating unit 1202 is connected to an error correcting unit 1203 which corrects a discrimination error which occurs due to waveform deterioration, interference, and thermal noise. A reproduction digital signal obtained after such signal processing is supplied to the reference value generator 403. A passing coordinate extracting unit 404 receives the reception signal detected by the receiving unit 106.

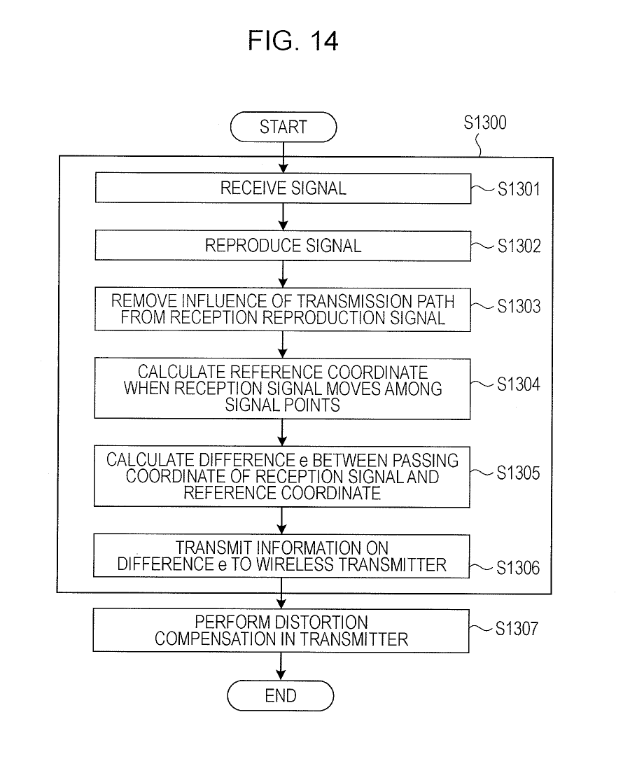

FIG. 14 illustrates a flowchart of processing for controlling the distortion compensation according to the fourth embodiment. The receiver 1200 performs processes included in step S1300, and a transmitter 101 performs a process of step S1307. First, the transmitter 101 transmits a signal which has not been subjected to distortion compensation, and the receiving unit 106 included in the receiver 1200 wirelessly receives the signal (in step S1301). Next, the reception signal is reproduced (in step S1302).

Then, the signal output from the receiving unit 106 is supplied to the waveform equalizing unit 1201, the interference compensating unit 1202, and the error correcting unit 1203 so that influence of linear distortion in the wireless transmission path is removed (in step S1303). The reception signal from which the influence of the linear distortion is removed is supplied to the reference value generator 403 included in a distortion detector 402. As described in the foregoing embodiment, the reference value generator 403 calculates reference coordinates when the reception signal moves among signal points (in step S1304). Here, passing coordinates correspond to reference values. Then, the comparing unit 405 calculates differences e between the reference coordinates and the passing coordinates extracted by the passing coordinate extracting unit 404 (in step S1305). The distortion detector 402 transmits data representing the differences e as a compensation signal D1 to the distortion compensating unit 102 included in the transmitter 101 (in step S1306). Then, the distortion compensating unit 102 included in the transmitter 101 performs distortion compensation in accordance with the differences e represented by the input compensation signal D1 (in step S1307).

According to the configuration described above, the receiver detects distortion using a reception signal. However, since the reference values are obtained by removing fading in the wireless transmission path, deterioration of a waveform due to rainfall, superposing of noise, and signal error due to such deterioration of communication quality. Accordingly, accuracy of calculation of coordinates which are passed when the reception signal moves among signal points can be improved. In this way, accuracy of determination as to whether overcompensation of a distortion amount or shortage of the distortion compensating amount occurs is improved, and accuracy of the distortion compensating amount can be improved.

### Fifth Embodiment

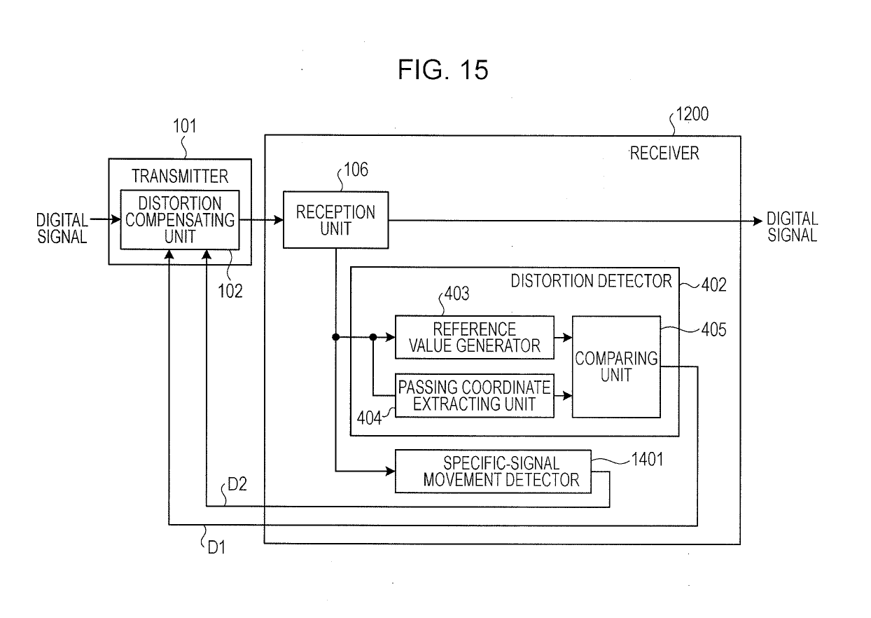

FIG. 15 illustrates a configuration of a nonlinear distortion compensation apparatus according to a fifth embodiment. In the fifth embodiment, movement among specific signal points in which power suitable for detection of distortion is generated is detected, a result of the distortion detection when a reception signal moves among the specific signal points is determined to be effective, and distortion compensation is performed.

In the fifth embodiment, a receiving unit 106 outputs a signal to a specific-signal movement detector 1401, and the specific-signal movement detector 1401 transmits an effective/ineffective signal D2 of distortion compensation to a distortion compensating unit 102 included in a transmitter 101. The specific-signal movement detector 1401 detects a plurality of signal points (for example, successive four signal points N−3, N−1, N+1, and N+3). When it is determined that the four signal points in which a signal has moved are specific signal points, the specific-signal movement detector 1401 outputs an effective signal D2 representing that the result of the detection of the distortion is effective. The specific-signal movement detector 1401 stores in a storing unit, not shown in FIG. 15, a pattern of movement among the specific signal points (N−3, N−1, N+1, and N+3) in which power suitable for the distortion detection is generated.

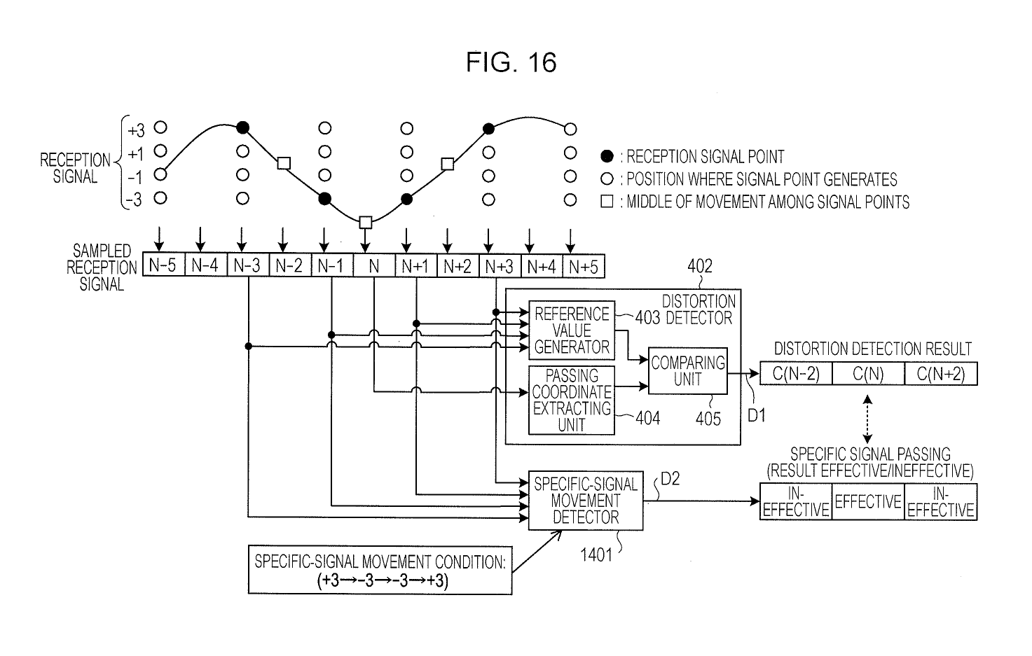

FIG. 16 illustrates a state of movement among the specified signal points detected by the specific-signal movement detector 1401. When a reception signal moves among signal points as shown in an upper portion of FIG. 16, the maximum power is generated at a sampled reception signal N. In this case, as with the third embodiment, the distortion detector 402 outputs information C(n) [n: N−2, N, N+2] on differences e as a compensation signal D1. Furthermore, the specific-signal movement detector 1401 detects a state in which a movement pattern (from +3, −3, −3, to +3) in which power distribution of passing coordinates (N−3, N−1, N+1, N+3) of the reception signal becomes close to the maximum power is generated, and outputs an effective signal D2 which represents that a result of distortion detection of the information C(N) of the differences e is effective. The distortion compensating unit 102 of the transmitter 101 performs the distortion compensation using the information C(N) of the differences e only when the effective/ineffective signal D2 is output. A specific-signal movement condition using the four signals is not limited to the condition shown in FIG. 16, that is, the pattern (from +3, −3, −3, to +3), and a reverse pattern (from −3, +3, +3, to −3) may be employed.

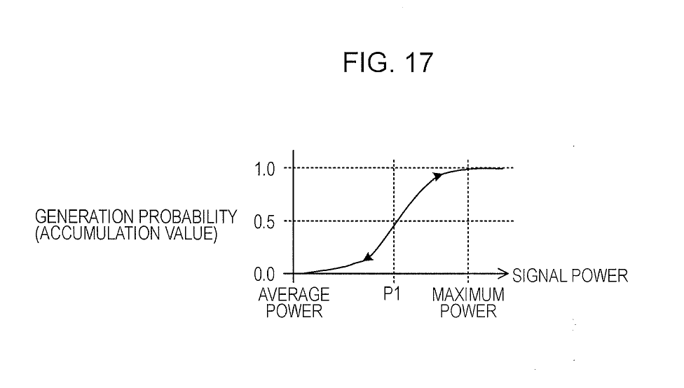

FIG. 17 illustrates a state of charged power of a reception signal which satisfies the specific-signal movement condition. An axis of abscissa denotes power of the signal and an axis of ordinate denotes a generation probability (accumulation value). The electric power of the reception signal N which satisfies the specific-signal movement condition is obtained by accumulating the power as shown in FIG. 17. Here, a reference value of the distortion detector 402 is set so as to be equal to a portion P1 shown in FIG. 17. The portion P1 is located in the middle of an average power and the maximum power. By this, distortion of the reception signal N which satisfies the specific-signal movement condition can be compensated for by performing the distortion compensation. If the receiving unit 106 receives the reception signal having appropriate electric power at the portion P1 as the result of the distortion compensation, a rate of output of a value “1” to output of a value “0” from the comparing unit 405 is balanced (refer to FIG. 7), and control of the distortion compensation is converged.

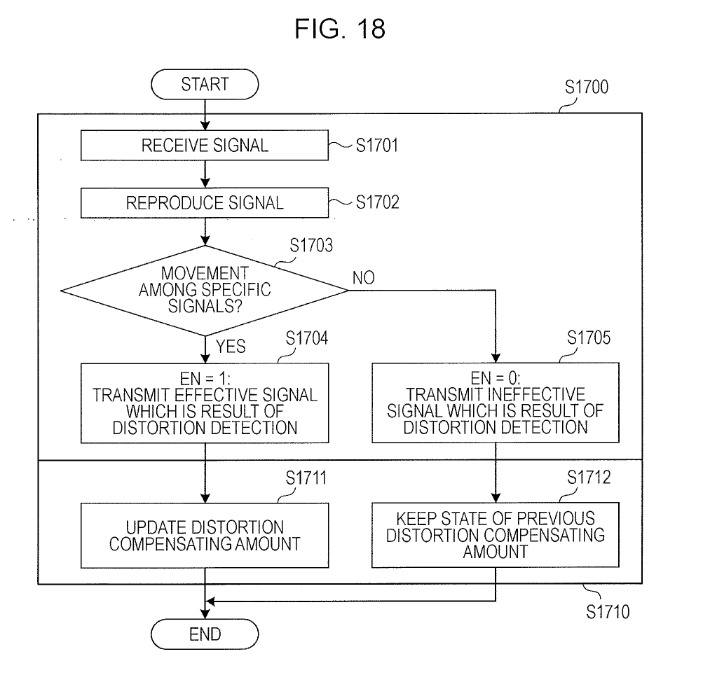

FIG. 18 illustrates a flowchart of processing for controlling distortion compensation according to the fifth embodiment. In FIG. 18, the receiver 1200 performs processes included in step S1700, and the transmitter 101 performs processes included in step S1710. First, the transmitter 101 transmits a signal which has not been the distortion compensation, and the receiving unit 106 of the receiver 1200 wirelessly receives the signal (in step S1701). Then, the reception signal is reproduced (in step S1702). Although not shown, as with the third embodiment, the distortion detector 402 outputs information C(N) on differences e which is a result of the distortion detection as a compensation signal D1.

The specific-signal movement detector 1401 determines whether the reception signal moves among specific signal points (in step S1703). When the determination is affirmative (“Yes” is selected in step S1703), an effective signal D2 (EN=1) representing that a compensation signal D1 is effective is transmitted to the distortion compensating unit 102 included in the transmitter 101 (in step S1704). By this, the distortion compensating unit 102 updates a distortion compensating amount (in step S1711). Here, the distortion compensating unit 102 obtains the received compensation signal D1 as a new distortion compensating amount.

On the other hand, when the determination is negative (“No” is selected in step S1703), an ineffective signal D2 (EN=0) representing that the compensation signal D1 is ineffective is transmitted to the distortion compensating unit 102 included in the transmitter 101 (in step S1705). By this, the distortion compensating unit 102 does not update the distortion compensating amount and holds a previous compensating amount (in step S1712). Here, the distortion compensating unit 102 does not obtain the compensation signal D1 even when the compensation signal D1 is supplied.

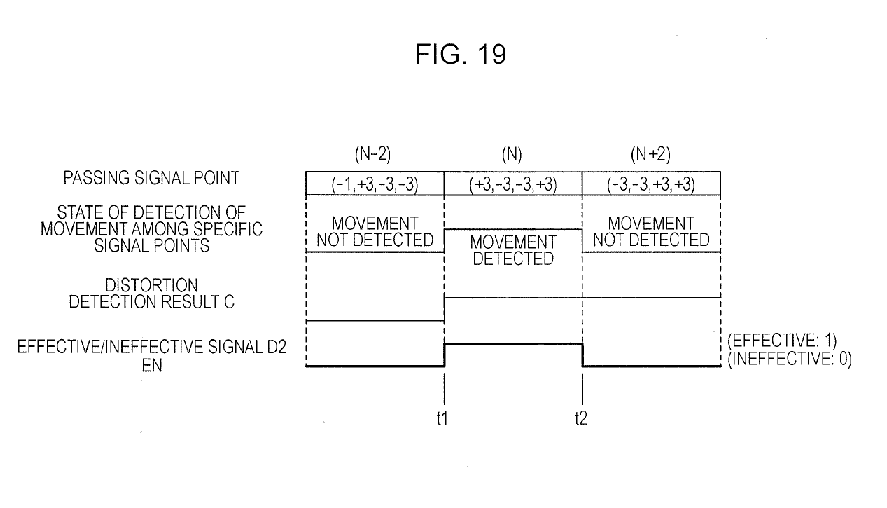

FIG. 19 illustrates a timing chart of signals. At a time point t1, the specific-signal movement detector 1401 detects generation of the movement of a reception signal having the pattern (from +3, −3, −3, to +3) in which power distribution of the passing coordinates (N−3, N−1, N+1, and N+3) of the reception signal is close to the maximum power. By this, the effective/ineffective signal D2 corresponding to the result C(N) of the distortion detection serving as the compensation signal D1 is output, and the distortion compensating unit 102 performs distortion compensation using a compensating amount in accordance with the result of the distortion detection. The effective signal D2 is output only during the specific pattern of movement among the signal points (in a period from the time point t1 to a time point t2). Accordingly, the compensating amount updated at the time point t1 is used in distortion compensation performed after the time point t2.

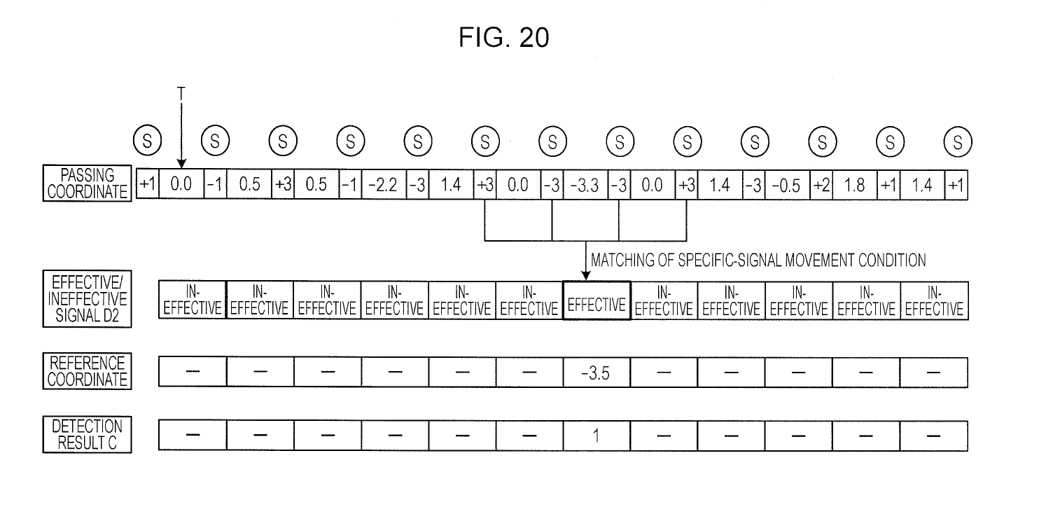

FIG. 20 illustrates a timing chart representing a concrete example of the detection of movement among specific signals. Passing coordinates of a reception signal is the same as those of FIG. 8. In the fifth embodiment, an effective signal D2 is obtained only when the specific pattern (from +3, −3, −3, to +3) in which power distribution of signal points S of the passing coordinates becomes close to the maximum power is generated, and a reference coordinate (−3.5) at this time is transmitted as a detection result C(N). In other periods before and after the generation of the specific pattern, when compared with the case of FIG. 8, the specific-signal movement pattern is not detected, and therefore, an ineffective signal D2 is transmitted.

With this configuration, the distortion compensating amount is updated when distortion occurs due to the maximum power by using the specific signal movement pattern which attains the maximum power and detecting the movement of the reception signal among the specific signal points, and on the other hand, signal points in which power is low and probability of generation of distortion is low and a distortion compensating amount at a time of movement among signal points is not used. Therefore, accuracy of the distortion compensation is improved. Accordingly, distortion compensation can be performed taking a state at a time when the reception signal moves among signal points which attains the maximum power into consideration. Consequently, deterioration of spectrum at a terminal of a transmission antenna can be corrected.

### Sixth Embodiment

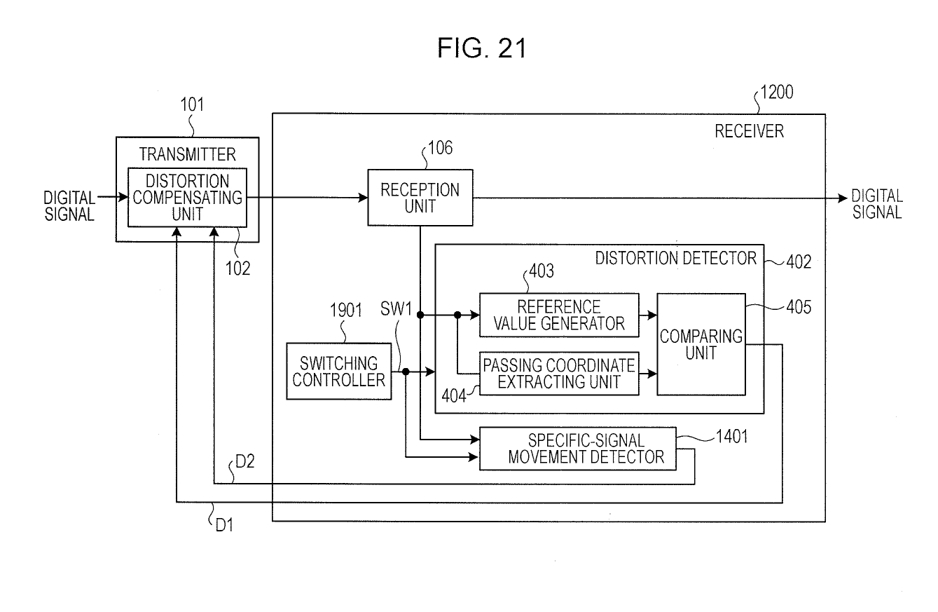

FIG. 21 illustrates a configuration of a nonlinear distortion compensation apparatus according to a sixth embodiment. In the sixth embodiment, as with the fifth embodiment, movement among specific signal points in which power suitable for distortion detection is generated is detected, a result of the distortion detection when a reception signal moves among the specific signal points is determined to be effective, and distortion compensation is performed. Then, as a specific condition of movement among the signal points, a first condition in which probability of generation of events which satisfy the first condition is high or a second condition in which probability of generation of events which satisfy the second condition is low but accuracy of distortion detection is high is selected so that convergence of a distortion compensation factor or accuracy of distortion detection is appropriately prioritized.

As shown in FIG. 21, the sixth embodiment is different from the fifth embodiment in that a switching controller 1901 is added to the configuration of the fifth embodiment (FIG. 15). Furthermore, a distortion detector 402 determines whether distortion occurs when a reception signal moves among, in addition to the four successive signal points (N−3, N−1, N+1, and N+3) described in the fifth embodiment, six successive signal points (N−5, N−3, N−1, N+1, N+3, and N+5). Furthermore, the specific-signal movement detector 1401 also detects movement among the specific four successive signal points and movement among the specific six signal points. Then, the switching controller 1901 determines whether a method for detecting distortion and a method for detecting movement of specific signals is performed using (1) the four successive signal points or (2) the six successive signal points by outputting a switching signal SW1. When the four successive signal points are used, control is converged fast, but accuracy of the distortion detection is low (first specific-signal movement condition). When the six successive signal points are used, the control is slowly converged, but high accuracy of the distortion detection is attained (second specific-signal movement condition).

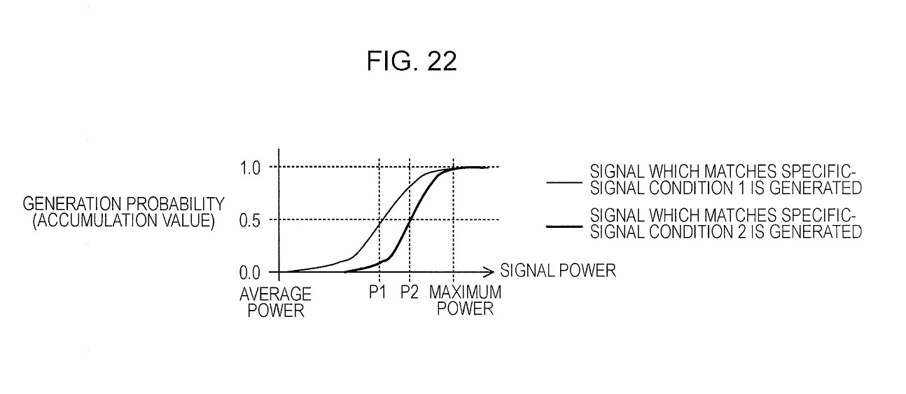

FIG. 22 illustrates a state of charged power of a reception signal which satisfies a specific-signal movement condition. When the second specific-signal movement condition is selected, the specific-signal movement detector 1401 uses the six signal points. In this case, as shown in FIG. 22, a center P2 of distribution of passing coordinates is closer to the maximum power relative to a center P1 of distribution of passing coordinates when the four signal points are used (first specific-signal movement condition). Accordingly, distortion detection can be performed with high electric power, and distortion compensation can be performed even for small distortion.

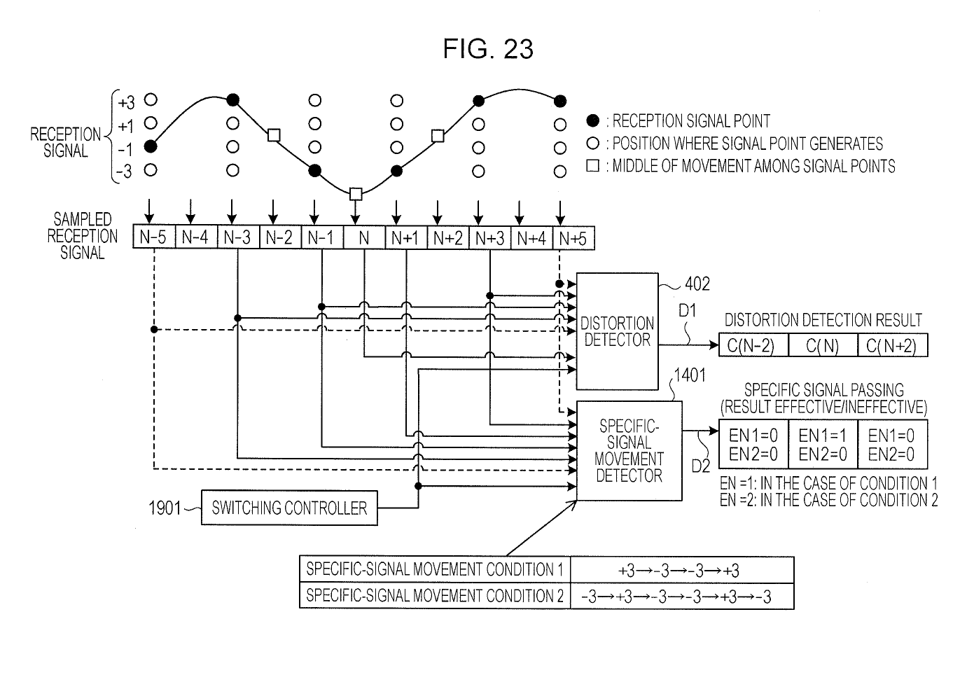

FIG. 23 illustrates switching of a state of detection of movement among specified signal points detected by the specific-signal movement detector 1401. In a case where a reception signal moves among signal points shown in an upper portion of FIG. 23, the maximum power is generated at a sampled reception signal N (similarly to the description of the fifth embodiment (FIG. 16)). Under the first specific-signal movement condition, as with the case of FIG. 16, an effective signal D2 representing that a result of distortion detection of information C(N) of differences e is effective is output. EN1 denotes a result of the first specific-signal movement condition, and a value 0 denotes “ineffective” and a value 1 denotes “effective”. EN2 denotes a result of the second specific-signal movement condition, and a value 0 denotes “ineffective” and a value 1 denotes “effective”.

On the other hand, under the second specific-signal movement condition, compensation can be performed even for small distortion. However, due to the strict condition, the number of generations of movement among signal points which satisfy the second specific-signal movement condition is reduced. In addition, time required for convergence of a control loop of distortion compensating control is larger than that of the first specific-signal movement condition. As shown in FIG. 23, the effective signal D2 is output in response to the information C(N) of the differences e under the first specific-signal movement condition whereas an ineffective signal D2 is output in response to the information C(N) of the differences e under the second specific-signal movement condition.

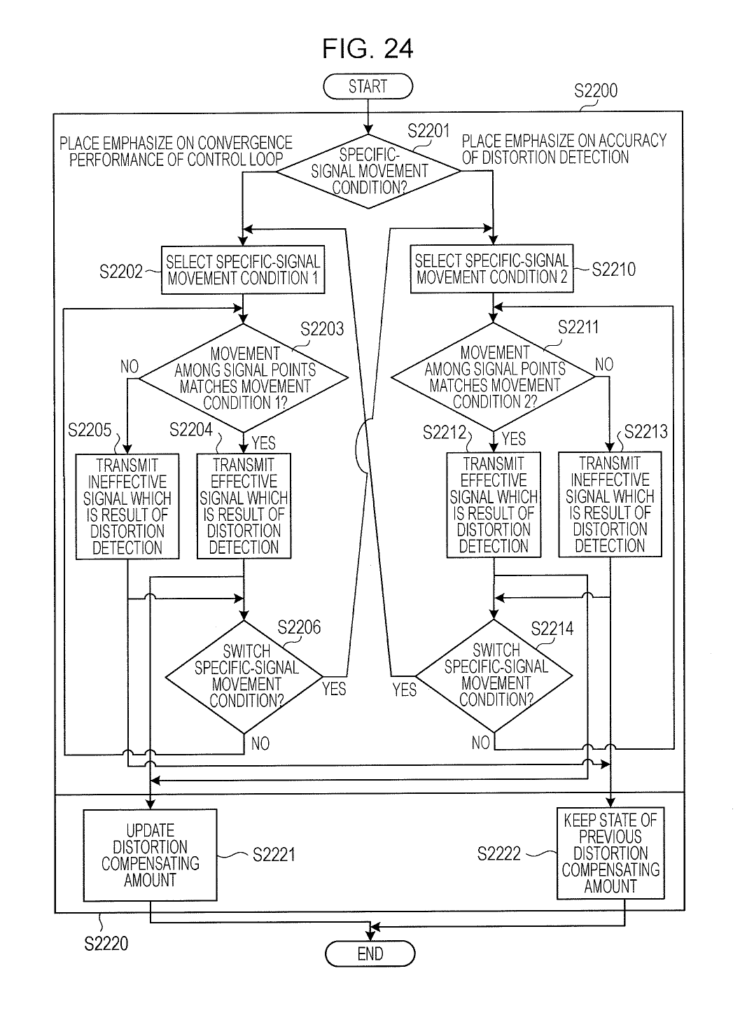

FIG. 24 illustrates a flowchart of processing for controlling distortion compensation according to the sixth embodiment. In FIG. 24, the receiver 1200 performs processes included in step S2200, and the transmitter 101 performs processes included in step S2220. FIG. 24 shows control processing performed in accordance with selection of a specific-signal movement condition. Furthermore, although not shown, when distortion compensation is started, as described in the fifth embodiment (FIG. 18), for example, the transmitter 101 transmits a signal which has not been subjected to distortion compensation and the receiving unit 106 of the receiver 1200 wirelessly receives the signal and reproduces the reception signal. Furthermore, the distortion detector 402 outputs information C(N) of differences e which is a result of distortion detection as a compensation signal D1.

First, a specific-signal movement condition is set (in step S2201). When it is determined that the convergence of the control loop is prioritized, the first specific-signal movement condition is selected (in step S2202) and the following processing is performed. The specific-signal movement detector 1401 determines whether movement of the reception signal matches the movement among signal points of the first specific-signal movement condition (in step S2203). When the determination is affirmative (“Yes” is selected in step S2203), an effective signal D2 which is a result of the distortion detection is transmitted (in step S2204), and the distortion compensating unit 102 of the transmitter 101 updates a compensating amount so that the distortion compensation is performed (in step S2221). When the determination is negative (“No” is selected in step S2203), an ineffective signal D2 which is a result of the distortion detection is transmitted (in step S2205), and the distortion compensating unit 102 of the transmitter 101 does not update the distortion compensating amount and performs the distortion compensation using a previous compensating amount (in step S2222). Thereafter, it is determined whether the current specific-signal movement condition is to be changed (in step S2206). When the determination is negative (“No” is selected in step S2206), the process returns to step S2203 and the processing from step S2203 onwards is performed. On the other hand, when the determination is affirmative (“Yes” is selected in step S2206), the second specific-signal movement condition is selected (the process proceeds to step S2210).

When it is determined that accuracy of the distortion detection is prioritized in step S2201, the second specific-signal movement condition is selected (in step S2210), and the following processing is performed. The specific-signal movement detector 1401 determines whether movement of the reception signal matches the movement among signal points of the second specific-signal movement condition (in step S2211). When the determination is affirmative (“Yes” is selected in step S2211), an effective signal D2 which is a result of the distortion detection is transmitted (in step S2212), and the distortion compensating unit 102 of the transmitter 101 updates a distortion compensating amount so that the distortion compensation is performed (in step S2221). When the determination is negative (“No” is selected in step S2211), an ineffective signal D2 which is a result of the distortion detection is transmitted (in step S2213), and the distortion compensating unit 102 of the transmitter 101 does not update the distortion compensating amount and performs the distortion compensation using a previous compensating amount (in step S2222). Thereafter, it is determined whether the current specific-signal movement condition is to be changed (in step S2214). When the determination is negative (“No” is selected in step S2214), the process returns to step S2211 and the processing from step S2211 onwards is performed. On the other hand, when the determination is affirmative (“Yes” is selected in step S2214), the first specific-signal movement condition is selected (the process proceeds to step S2202).

With this configuration, the distortion compensation can be performed taking a state of moving and passing among signal points having maximum power into consideration. Accordingly, spectrum deterioration which occurs at a transmission antenna terminal can be compensated for. In addition, since a plurality of patterns of specific signal movement in which the maximum power is generated are used, the first specific-signal movement condition in which control is converged fast but accuracy of the distortion detection is low and the second specific-signal movement condition in which the control is slowly converged but the accuracy of the detection of distortion is high can be switched from one to another. Accordingly, time required for convergence of a control loop and the accuracy of the distortion detection are selected so as to attain optimum control. Furthermore, in the foregoing example, the two conditions to be selected are provided. However, a specific-signal movement condition which uses a larger number of successive signal points and which attains higher detection accuracy may be added. In this case, a larger number of conditions to be selected may be provided.

### Seventh Embodiment

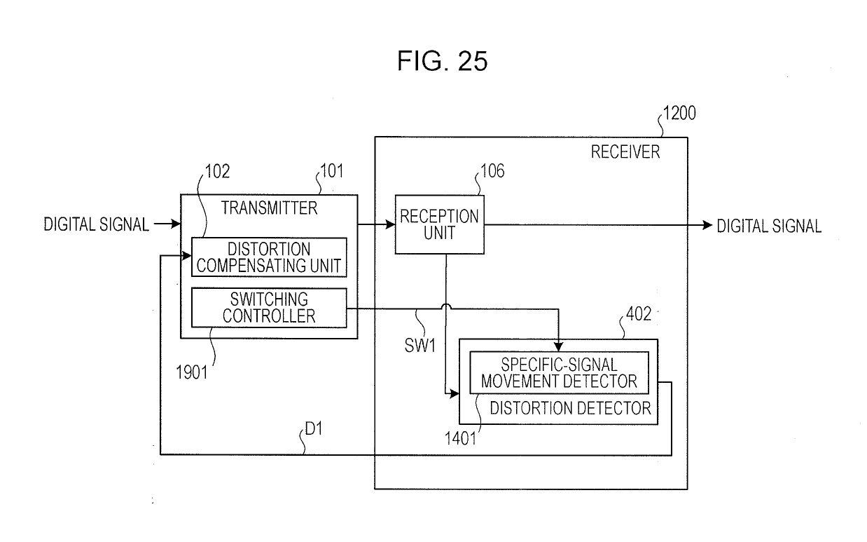

FIG. 25 illustrates a configuration of a nonlinear distortion compensation apparatus according to a seventh embodiment. The seventh embodiment is a modification of the sixth embodiment, and a switching controller 1901 which is the same as that described in the sixth embodiment is included in a transmitter 101.

The switching controller 1901 included in the transmitter 101 transmits a switching signal SW1 used for switching between the first and second specific-signal movement conditions from a distortion compensating unit 102 to a distortion detector 402.

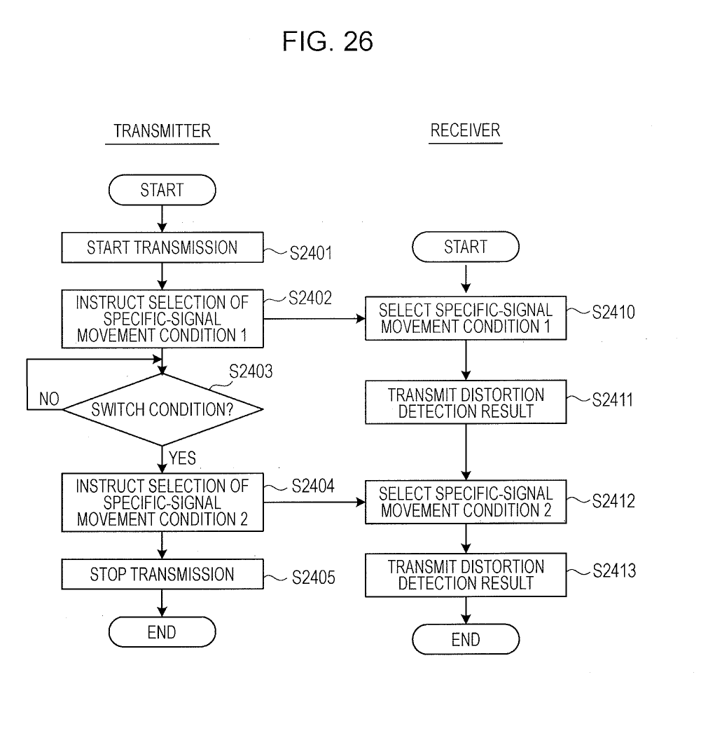

FIG. 26 illustrates a flowchart of switching of a specific-signal movement condition. The switching controller 1901 included in the transmitter 101 transmits the switching signal SW1 used for switching of a distortion detection condition to a receiver 1200 when power is supplied or when a state in which output is stopped is changed to a state in which output is started, for example (transmission is started: in step S2401). It is assumed that, first, the switching controller 1901 instructs selection of a first specific-signal movement condition (in step S2402). By this, a specific-signal movement detector 1401 included in a distortion detector 402 of the receiver 1200 selects the first specific-signal movement condition (in step S2410), detects distortion of a reception signal in accordance with the first specific-signal movement condition, and transmits a result of the distortion detection to the distortion compensating unit 102 included in the transmitter 101 (in step S2411).

Thereafter, if switching of the distortion detection condition is performed by the switching controller 1901 (after “No” is selected in step S2403, “Yes” is selected in step S2403), the switching signal SW1 used to switch the first specific-signal movement condition to the second specific-signal movement condition is transmitted (in step S2404). Then, the specific-signal movement detector 1401 included in the distortion detector 402 of the receiver 1200 selects the second specific-signal movement condition (in step S2412), detects distortion of the reception signal in accordance with the second specific-signal movement condition, and transmits a result of the distortion detection to the distortion compensating unit 102 included in the transmitter 101 (in step S2413). The processing described above performed by the transmitter 101 is continued until the transmission is stopped (in step S2405). For example, if distortion is not compensated for even though the distortion compensation is performed in accordance with the first or second specific-signal movement condition, transmission may be stopped for maintenance.

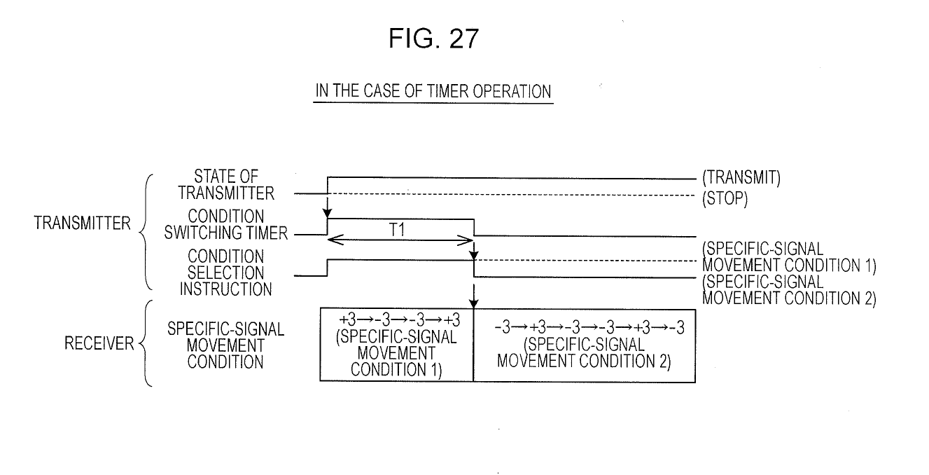

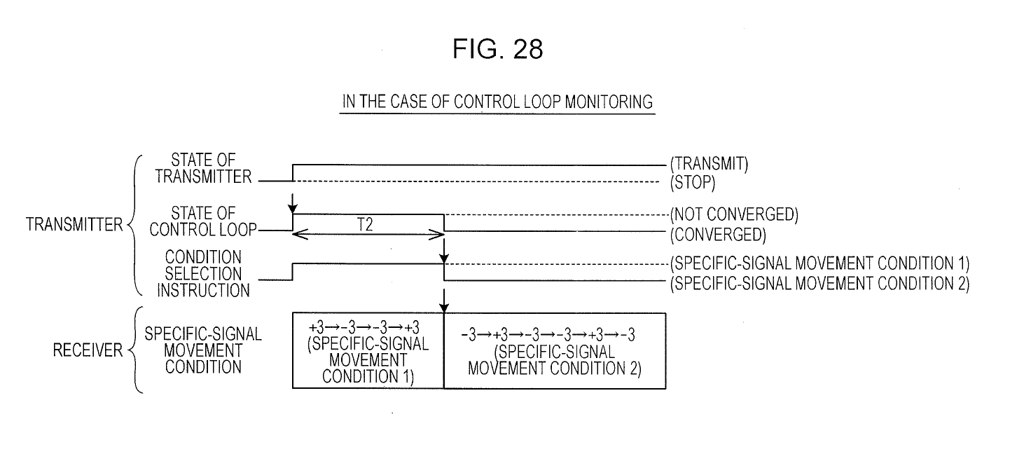

FIGS. 27 and 28 illustrate concrete examples of timings at which the specific-signal movement condition is changed. In the process for changing a condition (in step S2403) shown in FIG. 26, the convergence of the control loop is monitored and the switching signal SW1 is automatically transmitted after a predetermined period of time. FIG. 27 shows a timing chart for switching of a condition by timer operation. When the transmission is started, the transmitter 101 first transmits a switching signal SW1 for selecting the first specific-signal movement condition, and after a setting period T1, transmits a switching signal SW1 for selecting the second specific-signal movement condition.

FIG. 28 shows a timing chart for switching of a condition by monitoring the control loop. When the transmission is started, the transmitter 101 first transmits a switching signal SW1 for selecting the first specific-signal movement condition, and continues the control in accordance with the first specific-signal movement condition during a period T2 in which the control of the distortion compensation performed by the distortion compensating unit 102 is not converged. Thereafter, when the control of the distortion compensation performed by the distortion compensating unit 102 is converged, the transmitter 101 transmits a switching signal SW1 for selecting the second specific-signal movement condition, and the control performed in accordance with the first specific-signal movement condition is changed to control performed in accordance with the second specific-signal movement condition.

With this configuration, the distortion compensation can be performed taking a state of moving and passing among signal points having maximum power into consideration. Accordingly, spectrum deterioration which occurs at a transmission antenna terminal can be compensated for. In addition, the control loop can be quickly converged from an initial state such as a state when power is supplied, and accuracy of the distortion compensation after the convergence can be improved. Furthermore, the configuration described above can be employed in a case where a circuit of the distortion compensating unit 102 and a circuit of the distortion detector 402 are disposed on different circuit substrates. Also in this case, the distortion compensation is quickly performed.

### Eighth Embodiment

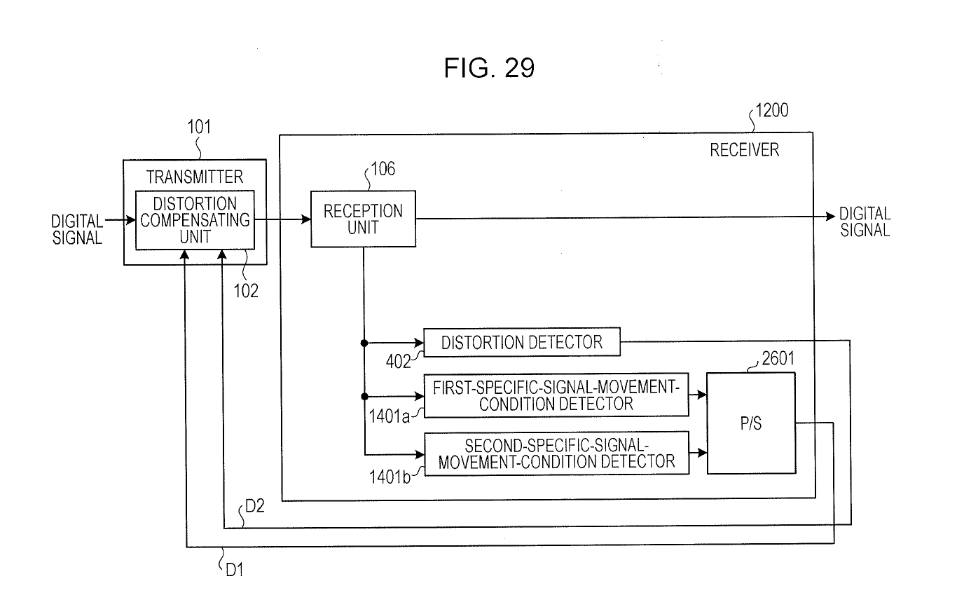

FIG. 29 illustrates a configuration of a nonlinear distortion compensation apparatus according to an eighth embodiment. The eighth embodiment is a modification of the sixth embodiment (FIG. 21), and is configured such that it is determined whether a reception signal satisfies a first or second specific-signal movement condition.

A distortion detector 402 compares a reference values for four successive signal points (N−3, N−1, N+1, and N+3) and a reference value for six successive signal points (N−5, N−3, N−1, N+1, N+3, and N+5) with a signal passing coordinate (N) so as to determine whether distortion occurs. Results of the comparisons between the two reference value with the passing coordinate (N) are transmitted to a distortion compensating unit 102 as compensation signals D1 which have been converted into serial signals (C, C2).

Examples of a specific-signal movement condition in which a result of distortion detection is enabled include a first specific-signal movement condition in which convergence of a control loop is prioritized and a second specific-signal movement condition in which accuracy of distortion compensation is prioritized. A receiver 1200 includes a first-specific-signal-movement-condition detector 1401a which determines whether a reception signal satisfies the first specific-signal movement condition and a second-specific-signal-movement-condition detector 1401b which determines whether the reception signal satisfies the second specific-signal movement condition. The first-specific-signal-movement-condition detector 1401a determines whether four successive signal points satisfy a specific condition. The second-specific-signal-movement-condition detector 1401b determines whether six signal points satisfy a specific condition. Signals output from the two specific-signal movement detectors (1401a and 1401b) are converted into a single serial signal by a P/S converting circuit 2601, and the serial signal is transmitted to the distortion compensating unit 102 as an effective/ineffective signal D2.

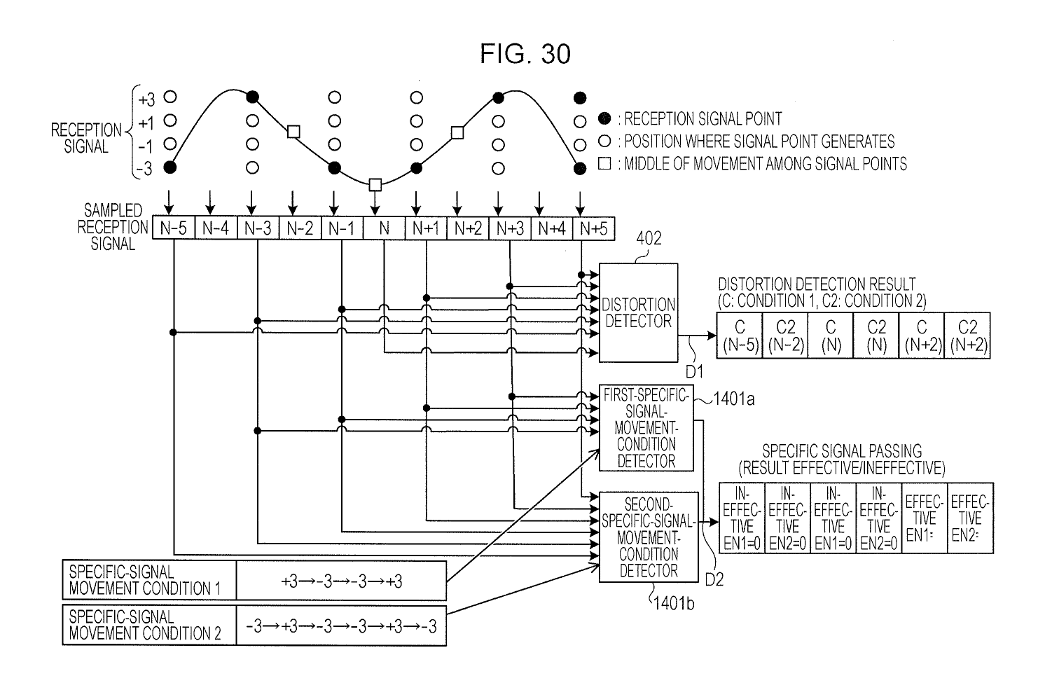

FIG. 30 illustrates states of detection of movement among specific signal points detected by the specific-signal movement detectors 1401a and 1401b. As shown in FIG. 30, the first-specific-signal-movement-condition detector 1401a detects movement of a certain pattern (from +3, −3, −3, to +3) and movement of a reverse pattern (from −3, +3, +3, to −3) which are included in the first specific-signal movement condition. The second-specific-signal-movement-condition detector 1401b detects a movement of a certain pattern (from −3, +3, −3, −3, +3, to −3) shown in FIG. 30 and movement of a reverse pattern (from +3, −3, +3, +3, −3, +3) which are included in the second specific-signal movement condition. Then, each of the specific-signal-movement-condition detectors 1401a and 1401b transmits an effective/ineffective signal D2 at a timing when a movement detection result EN1 for the first specific-signal movement condition or a movement detection result EN2 for the second specific-signal movement condition is output.

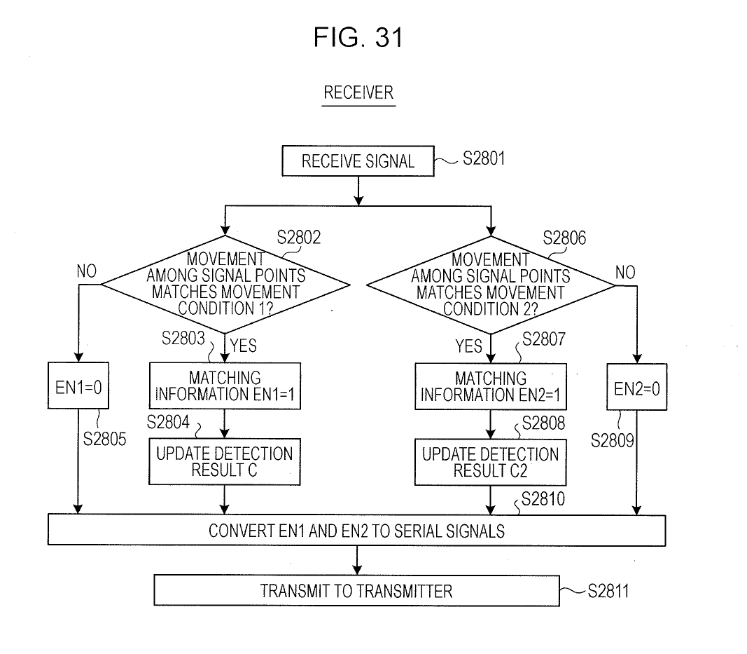

FIG. 31 illustrates a flowchart of processing for detecting matching of a specific-signal movement condition. The receiver 1200 performs this processing. When the receiver 1200 receives a signal (in step S2801), the first-specific-signal-movement-condition detector 1401a and the second-specific-signal-movement-condition detector 1401b simultaneously determine whether movement of a reception signal satisfies the respective conditions. The first-specific-signal-movement-condition detector 1401a determines whether the movement of the reception signal satisfies the first specific-signal movement condition (in step S2802). When the determination is affirmative (“Yes” is selected in step S2802), “1” is assigned to a value EN1 as matching information (in step S2803), a detection result C of the distortion detector 402 is updated (in step S2804), and the process proceeds to step S2810. When the determination is negative (“No” in step S2802), “0” is assigned to the value EN1 (in step S2805), and the process proceeds to step S2810.

The second-specific-signal-movement-condition detector 1401b determines whether the movement of the reception signal satisfies the second specific-signal movement condition (in step S2806). When the determination is affirmative (“Yes” is selected in step S2806), “1” is assigned to a value EN2 as matching information (in step S2807), a detection result C2 of the distortion detector 402 is updated (in step S2808), and the process proceeds to step S2810. When the determination is negative (“No” is selected in step S2806), “0” is assigned to the value EN2 (in step S2809), and the process proceeds to step S2810.

In step S2810, the matching information EN1 and EN2 are converted into serial signals (in step S2810), and the effective/ineffective signal D2 and the compensation signal D1 are transmitted to the distortion compensating unit 102 included in the transmitter 101 (in step S2811).

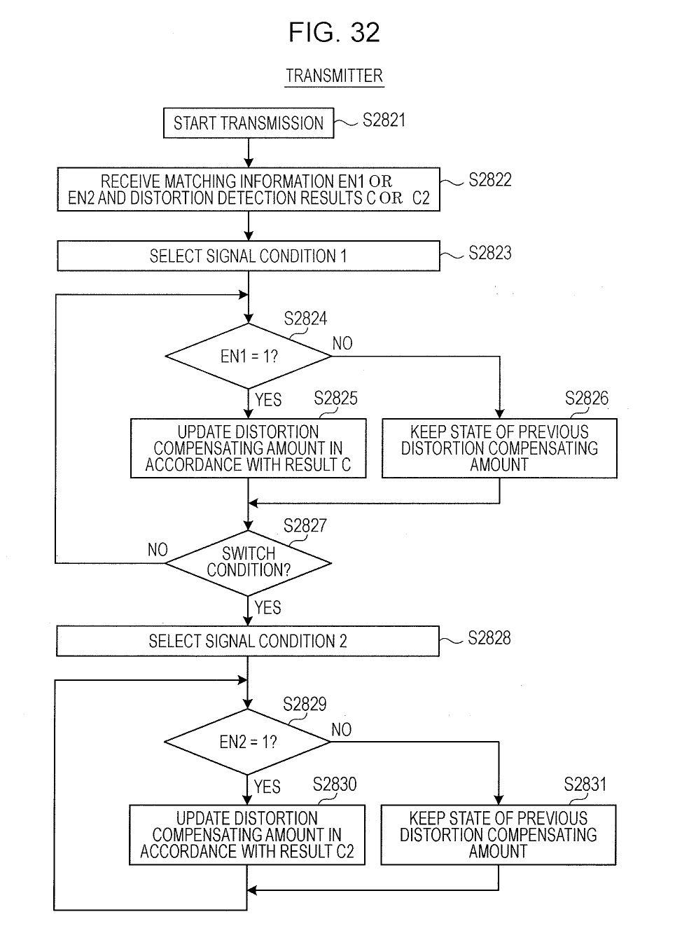

FIG. 32 illustrates a flowchart of the processing for detecting matching of the specific-signal movement condition. The transmitter 101 performs the processing. After transmission is started (in step S2821), the distortion compensating unit 102 included in the transmitter 101 receives the matching information EN1 or EN2 (effective/ineffective signal D2) and the distortion detection result C or C2 (compensation signal D1) (in step S2822). The distortion compensating unit 102 selects the first specific-signal movement condition (in step S2823) when a control loop is in an initial state, for example, immediately after power is supplied, and enhances convergence of the control loop using the detection result C(N) in which the number of generation of movement among signal points which matches the first specific-signal movement condition is large. Here, when the value EN1 is “1” representing “effective” (“Yes” is selected in step S2824), a distortion compensating amount is updated in accordance with the distortion detection result C (in step S2825). On the other hand, when the value EN1 is “0” representing “ineffective” (“No” is selected in step S2824), the distortion compensation is performed using a previous distortion compensating amount instead of the distortion detection result C represented by the received compensation signal D1 (in step S2826).

Thereafter, it is determined whether the condition is to be changed (in step S2827). As is described in the seventh embodiment, the distortion compensating unit 102 does not change the condition until a predetermined period of time has passed or while the control loop is not converged (“No” is selected in step S2827), and the process returns to step S2824. On the other hand, after the predetermined period of time or after the control loop is converged, the condition is changed (“Yes” is selected in step S2827).

As described above, after the convergence of the control loop progresses, distortion compensation is performed using the detection result C2(N) which is obtained with high detection accuracy. First, the second specific-signal movement condition is selected (in step S2828). When the value of EN2 is “1” representing “effective” (“Yes” is selected in step S2829), the distortion compensating amount is updated in accordance with the distortion detection result C2 (in step S2830). On the other hand, when the value of EN2 is “0” representing “ineffective” (“No” is selected in step S2829), distortion compensation is performed using a previous distortion compensating amount instead of the distortion detection result C2 represented by the received compensation signal D1 (in step S2831).

With this configuration, the distortion compensation can be performed taking a state of moving and passing among signal points having maximum power into consideration. Accordingly, spectrum deterioration which occurs at a transmission antenna terminal can be compensated for. In addition, since matching with the specific-signal movement conditions can be simultaneously detected, oversight of condition matching which occurs in a configuration in which the detection conditions are switched from one to another can be prevented. Accordingly, the control loop can be quickly converged from the initial state, and in addition, high accuracy of the distortion compensation after the convergence can be ensured. Furthermore, as a modification of the configuration described above, the distortion detector 402 may supply the compensation signal D1 to the P/S converting circuit 2601, and the compensation signal D1 and the effective/ineffective signal D2 may be collectively converted into serial signals.

### Ninth Embodiment

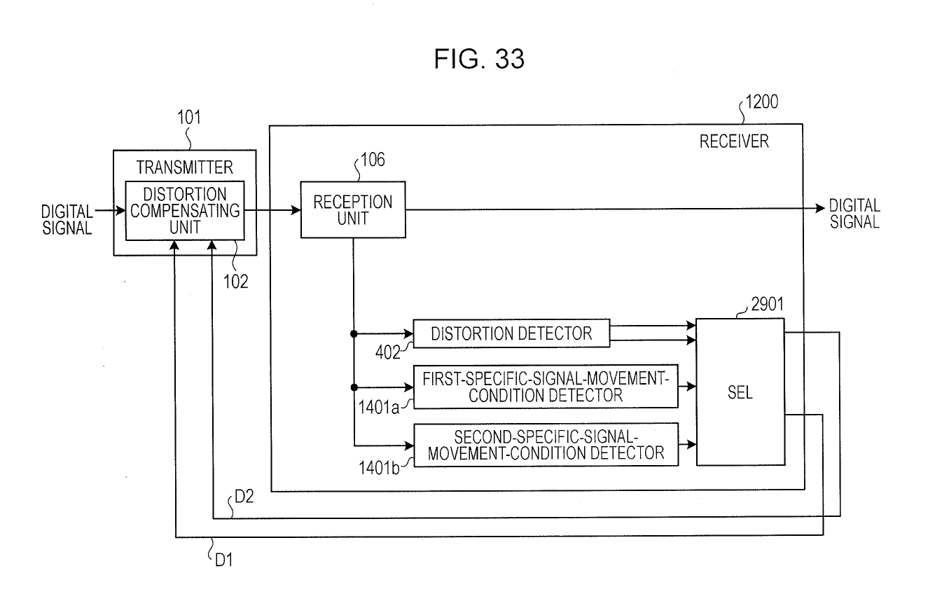

FIG. 33 illustrates a configuration of a nonlinear distortion compensation apparatus according to a ninth embodiment. The ninth embodiment is a modification of the eighth embodiment (FIG. 29) and is configured such that it is determined whether a reception signal matches a first or second specific-signal movement condition and a method for transmitting a detection result is changed depending on the condition.

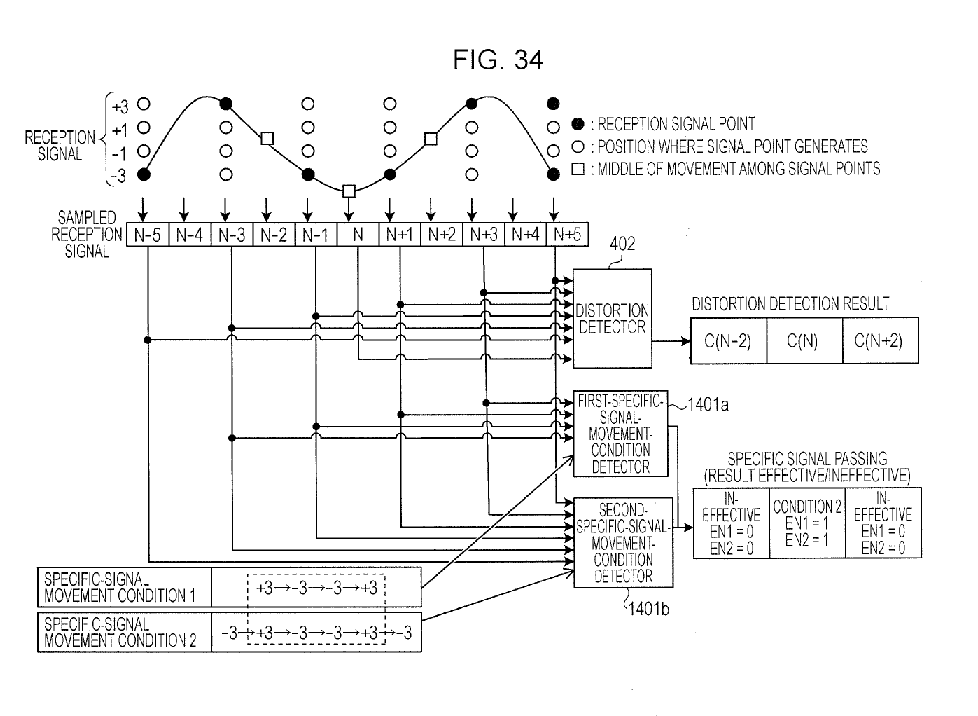

Examples of a specific-signal movement condition in which a result of distortion detection is enabled include, as with the eighth embodiment, a first specific-signal movement condition in which convergence of a control loop is prioritized and a second specific-signal movement condition in which accuracy of distortion compensation is prioritized. In addition, the second specific-signal movement condition includes content of the first specific-signal movement condition so that the second specific-signal movement condition includes a large number of condition items (in a range represented by a dotted line shown in FIG. 34). Accordingly, when movement of a reception signal satisfies the first specific-signal movement condition, a detection result corresponding to the first specific-signal movement condition is transmitted. On the other hand, when the movement of the reception signal satisfies the second specific-signal movement condition, a detection result corresponding to the second specific-signal movement condition is transmitted. By this, a distortion compensating unit 102 performs distortion compensation in accordance with the first specific-signal movement condition until the movement of the reception signal satisfies the second specific-signal movement condition, and after the second specific-signal movement condition is selected, distortion compensation in accordance with the second specific-signal movement condition is performed.

In the configuration shown in FIG. 33, a selection circuit (SEL) 2901 selects and outputs a detection result (effective/ineffective signal D2) of the matched first or second specific-signal movement condition and a distortion detection result (compensation signal D1) corresponding to the specific-signal movement condition.

FIG. 34 illustrates a state of detection of movement of specified signal points detected by first and second specific-signal movement detectors 1401a and 1401b. A state in which a reception signal moves among signal points is the same as that of the eighth embodiment (FIG. 30). When the second-specific-signal-movement-condition detector 1401b determines that the movement of the reception signal among signal points satisfies the second specific-signal movement condition, the first specific-signal movement condition is also satisfied (the range represented by the dotted line shown in FIG. 34). When only the first specific-signal movement condition is satisfied, the selection circuit 2901 transmits a distortion detection result C corresponding to the first specific-signal movement condition as a compensation signal D1. When the second specific-signal movement condition is satisfied, the selection circuit 2901 transmits a distortion detection result C2 corresponding to the second specific-signal movement condition as a compensation signal D1 to the distortion compensating unit 102. Simultaneously, when the second specific-signal movement condition is satisfied (EN1=1 and EN2=1 in FIG. 34), the selection circuit 2901 transmits EN1=1 and EN2=1 to the distortion compensating unit 102 as an effective/ineffective signal D2.

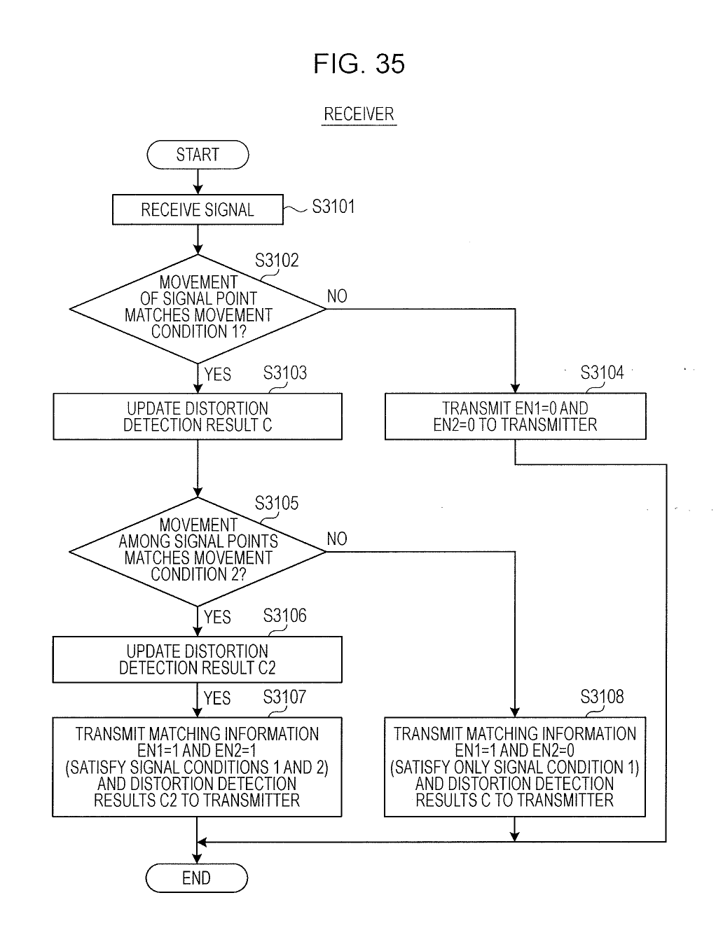

FIG. 35 illustrates a flowchart of processing for detecting matching of a specific-signal movement condition. A receiver 1200 performs this processing. When the receiver 1200 receives a signal (in step S3101), the first-specific-signal-movement-condition detector 1401a and the second-specific-signal-movement-condition detector 1401b simultaneously determine whether movement of a reception signal satisfies the respective conditions. The first-specific-signal-movement-condition detector 1401a determines whether the movement of the reception signal satisfies the first specific-signal movement condition (in step S3102). When the determination is affirmative (“Yes” is selected in step S3102), a detection result C of the distortion detector 402 is updated (in step S3103), and the process proceeds to step S3105. When the determination is negative (“No” is selected in step S3102), “0” is assigned to the values EN1 and EN2 (representing an ineffective distortion detection result) and the values EN1 and EN2 are transmitted to a transmitter 101 (in step S3104).

In step S3105, the second-specific-signal-movement-condition detector 1401b determines whether the second specific-signal movement condition is satisfied. When the determination is affirmative (“Yes” is selected in step S3105), the detection result C of the distortion detector 402 is updated to the detection result C2 (in step S3106). Then, the second-specific-signal-movement-condition detector 1401b assigns “1” to the values of EN1 and EN2 (the first and second specific-signal movement conditions are satisfied) (in step S3107), and transmits the distortion detection result C2 to the transmitter 101 (in step S3107). On the other hand, when the determination is negative (“No” is selected in step S3105), “1” is assigned to the value EN1 of the matching information and “0” is assigned to the value EN2 (representing that only the first specific-signal movement condition is satisfied), and the distortion detection result C is transmitted to the transmitter 101 (in step S3108).

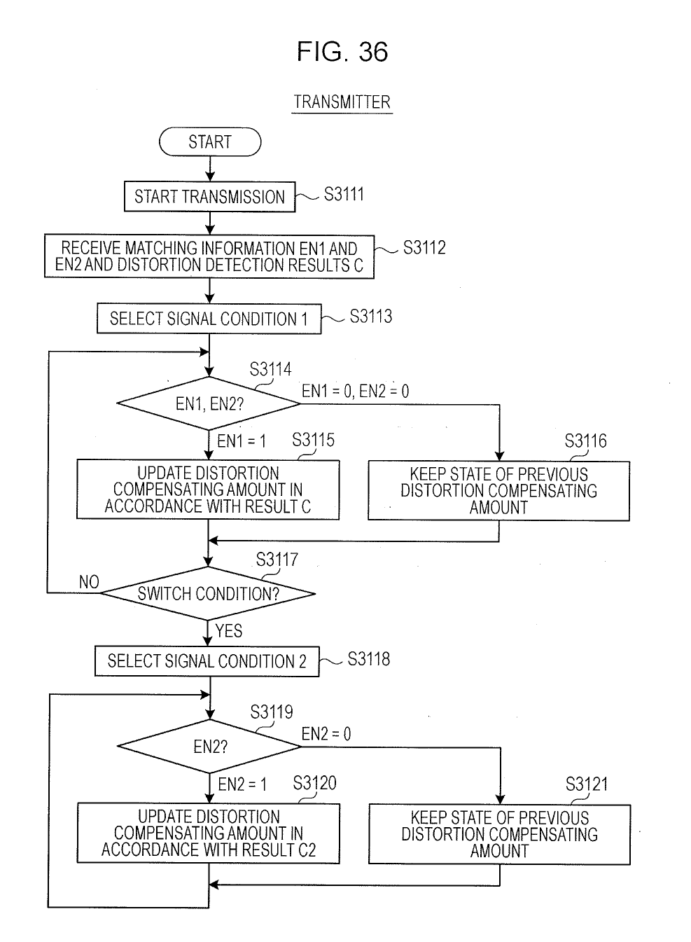

FIG. 36 illustrates a flowchart of the processing for detecting matching of a specific-signal movement condition. The transmitter 101 performs this processing. After transmission is started (in step S3111), the distortion compensating unit 102 included in the transmitter 101 receives the matching information EN1 and EN2 (effective/ineffective signal D2) and the distortion detection result C (compensation signal D1) transmitted from the receiver 1200 (in step S3112). The distortion compensating unit 102 selects the first specific-signal movement condition when a control loop is in an initial state, for example, immediately after power is supplied (in step S3113), and progresses convergence of the control loop using the detection result C(N) in which a large number of movements among signal points which satisfy the first specific-signal movement condition are generated. Next, the values which have been assigned to the EN1 and EN2 are determined (in step S3114). When the “1” representing “effective” has been assigned to the “EN1” (the value of EN2 is negligible) (EN1=1 in step S3114), a distortion compensating amount is updated in accordance with the distortion detection result C (in step S3115). On the other hand, if the values of EN1 and EN2 are “0” representing “ineffective” (EN1=0 and EN2=0 in step S3114), distortion compensation is performed while a previous compensating amount is maintained without using the distortion detection result C represented by the received compensation signal D1 (in step S3116).

Thereafter, it is determined whether the condition is to be changed (in step S3117). As is described in the seventh embodiment, the distortion compensating unit 102 does not change the condition until a predetermined period of time has passed or while the control loop is not converged (“No” is selected in step S3117), and the process returns to step S3114. On the other hand, after the predetermined period of time or after the control loop is converged, the condition is changed (“Yes” is selected in step S3117).

As described above, after the convergence of the control loop progresses, distortion compensation is performed using the detection result C2(N) which is obtained with high detection accuracy. First, the second specific-signal movement condition is selected (in step S3118). When the value of EN2 is “1” representing “effective” (EN2=1 in step S3119), the distortion compensating amount is updated in accordance with the distortion detection result C2 (in step S3120). On the other hand, when the value of EN2 is “0” representing “ineffective” (EN2=0 in step S3119), distortion compensation is performed using a previous distortion compensating amount instead of the distortion detection result C2 represented by the received compensation signal D1 (in step S3121).

With this configuration, the distortion compensation can be performed taking a state of moving and passing among signal points having maximum power into consideration. Accordingly, spectrum deterioration which occurs at a transmission antenna terminal can be compensated for. In addition, since matching with the specific-signal movement conditions can be simultaneously detected, oversight of condition matching which occurs in a configuration in which the detection conditions are switched from one to another can be prevented. Furthermore, when the control loop is in an initial state, the convergence of the control loop is enhanced using the detection result in which a large number of movements among signal points corresponding to the first specific-signal movement condition are generated, and after the convergence of the loop progresses, distortion compensation can be performed with high accuracy using only the detection result which has high accuracy and which corresponds to the second specific-signal movement condition.

### Tenth Embodiment

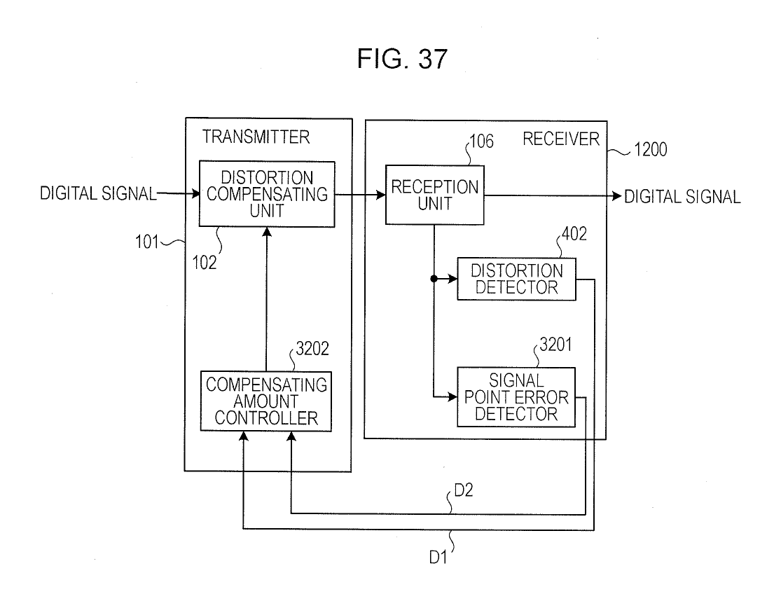

FIG. 37 illustrates a configuration of a nonlinear distortion compensation apparatus according to a tenth embodiment. In the tenth embodiment, a distortion detection result is ineffective when a difference between a coordinate of a received signal point and a regular coordinate is larger than a predetermined threshold value.

In FIG. 37, a receiving unit 106 supplies a signal to a signal-point error detector 3201. The signal-point error detector 3201 detects a distance (difference) between a signal-point coordinate of the reception signal and a regular signal-point coordinate. When the difference is larger than a reference value, an ineffective signal D2 is output. A transmitter 101 includes a compensating-amount controller 3202. The compensating-amount controller 3202 receives a compensation signal D1 and an effective/ineffective signal D2. When receiving the ineffective signal D2, the compensating-amount controller 3202 outputs an ineffective compensation signal D1 which is ineffective to a distortion compensating unit 102. The compensating-amount controller 3202 may be included in the receiver 1200.

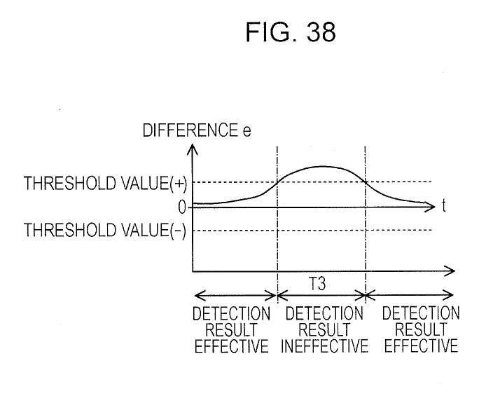

FIG. 38 illustrates an example of detection performed by the signal-point error detector 3201. An axis of abscissa denotes time and an axis of ordinate denotes an error (difference). A threshold value of a predetermined range from a point smaller than the center between the coordinate of the received signal point and the regular coordinate to a point larger than the center is set to the signal-point error detector 3201. The signal-point error detector 3201 enables a distortion detection result while the signal-point coordinate of the reception signal is included in the range of the threshold value with the regular signal-point coordinate as the center whereas the signal-point error detector 3201 disables the distortion detection result while the signal-point coordinate of the reception signal is out of the range of the threshold value, that is, during a period T3. When fading is generated, the signal-point coordinate of the reception signal is out of the range of the threshold value. Accordingly, a distortion detection result including detection of distortion due to fading can be made ineffective.

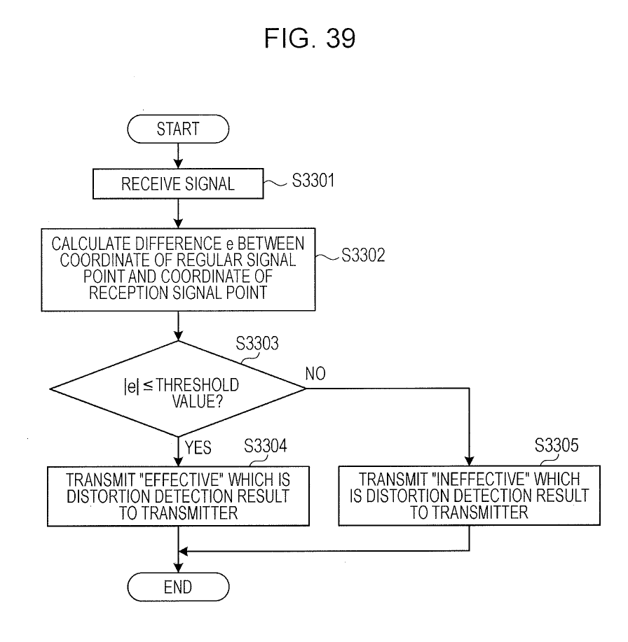

FIG. 39 illustrates a flowchart of processing for controlling distortion compensation according to the tenth embodiment. Processing performed by the signal-point error detector 3201 is extracted and shown in FIG. 39. When a receiving unit 106 receives a signal (in step S3301), a distance (difference e) between a regular signal-point coordinate and a signal-point coordinate of the reception signal after the reception signal is reproduced is calculated (in step S3302). Next, an absolute value of the difference e is compared with a threshold value. Specifically, when a formula |e|≦(threshold value) is satisfied (“Yes” is selected in step S3303), an effective signal D2 which enables the distortion detection result is transmitted to the transmitter 101 (in step S3304). On the other hand, when a formula |e|>(threshold value) is satisfied (“No” is selected in step S3303), an ineffective signal D2 which disables the distortion detection result is transmitted to the transmitter 101 (in step S3305).

With this configuration, irrespective of magnitude of power at a signal point, deviation (error) from a regular position of the signal point is monitored, and when the error is larger than the reference value, it is determined that fading, for example, is generated. Thereafter, the distortion detection result including detection of distortion due to the fading is disabled. By this, distortion compensation can be performed without influence of deterioration of a waveform which occurs due to fading, for example, generated in a wireless transmission path, and accuracy of compensation is prevented from being deteriorated.

### Eleventh Embodiment

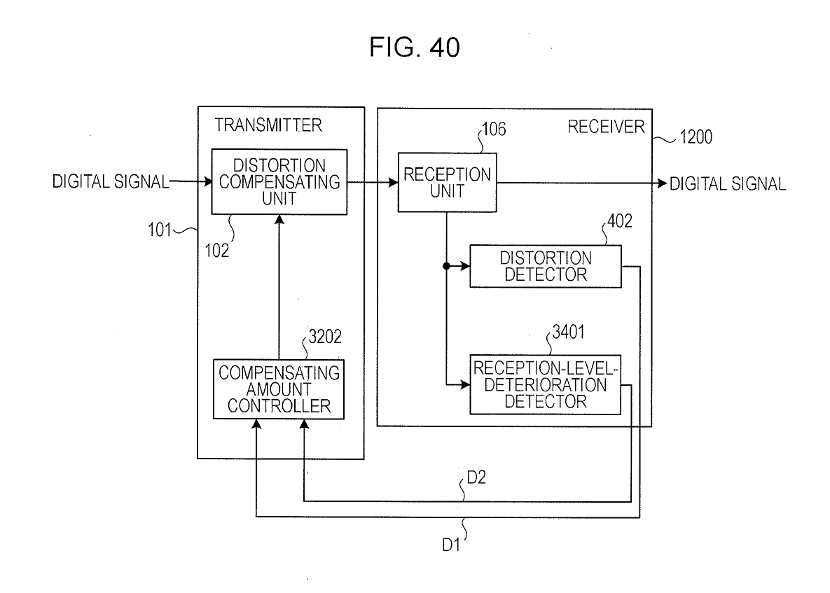

FIG. 40 illustrates a configuration of a nonlinear distortion compensation apparatus according to an eleventh embodiment. In the eleventh embodiment, reception power of a reception signal is detected, and a distortion detection result is disabled when the reception power is smaller than a predetermined threshold value.

In FIG. 40, a receiving unit 106 outputs a signal to a reception-level deterioration detector 3401. The reception-level deterioration detector 3401 monitors the reception power, and when the reception power becomes smaller than the predetermined threshold value, an ineffective signal D2 is output. A transmitter 101 includes, as with the tenth embodiment, a compensating-amount controller 3202. The compensating-amount controller 3202 receives a compensation signal D1 and an effective/ineffective signal D2. When receiving the ineffective signal D2, the compensating-amount controller 3202 outputs the ineffective compensation signal D1 to a distortion compensating unit 102. The compensating-amount controller 3202 may be included in a receiver 1200.

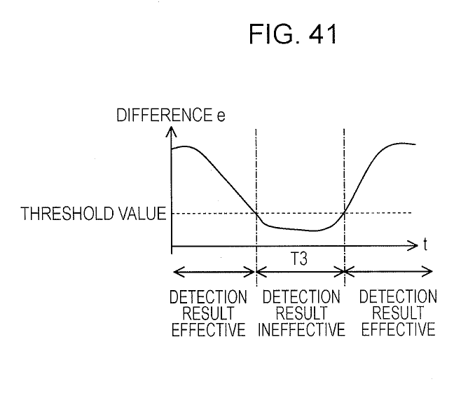

FIG. 41 illustrates an example of detection performed by the reception-level deterioration detector 3401. An axis of abscissa denotes time and an axis of ordinate denote the reception power. A threshold value which is determined on the basis of predetermined reception power is set to the reception-level deterioration detector 3401. Then, the reception-level deterioration detector 3401 enables the distortion detection result while the power of the reception signal is equal to or larger than the threshold value, whereas the reception-level deterioration detector 3401 disables the distortion detection result in a period T3 in which the power of the reception signal is smaller than the threshold value. The power of the reception signal becomes smaller than the threshold value due to fading or rainfall, for example, and a distortion detection result including detection of distortion due to the fading and the rainfall can be disabled.

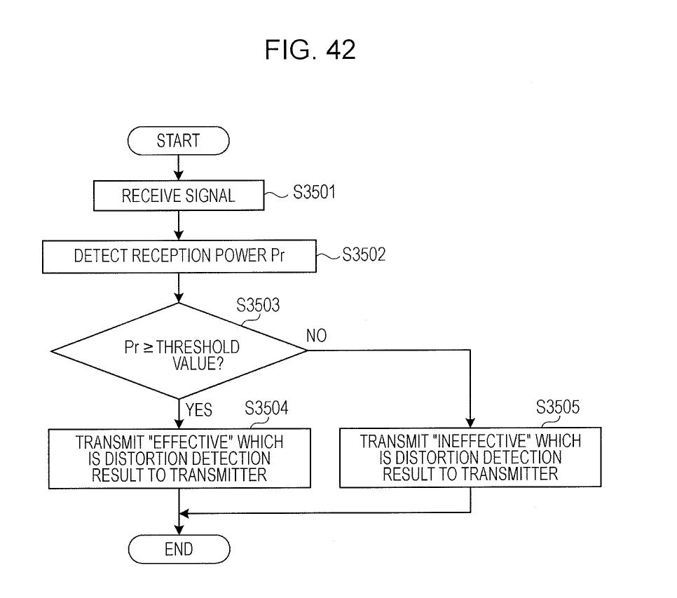

FIG. 42 illustrates a flowchart of processing for controlling distortion compensation according to the eleventh embodiment. Processing performed by the reception-level deterioration detector 3401 is extracted and shown in FIG. 42. When the receiving unit 106 receives a signal (in step S3501), a reception power Pr of the reception signal is detected (in step S3502). Then, the reception power Pr is compared with the threshold value. Specifically, when the reception power Pr is equal to or larger than the threshold value (“Yes” in step S3503), an effective signal D2 which enables a distortion detection result is transmitted to the transmitter 101 (in step S3504). On the other hand, when the reception power Pr is smaller than the threshold value (“No” in step S3503), an ineffective signal D2 which disables the distortion detection result is transmitted to the transmitter 101 (in step S3505).

With this configuration, the reception power of the reception signal is detected, and when the reception power is smaller than the threshold value, it is determined that this is caused by fading or rainfall. Accordingly, a distortion detection result including detection of distortion due to fading and rainfall, for example, is disabled. By this, distortion compensation can be performed without influence of deterioration of a waveform due to deterioration of a signal to noise ratio (SNR) caused by deterioration of the reception power due to fading generated in a wireless transmission path or rainfall, and deterioration of accuracy of the compensation can be avoided.

### Twelfth Embodiment

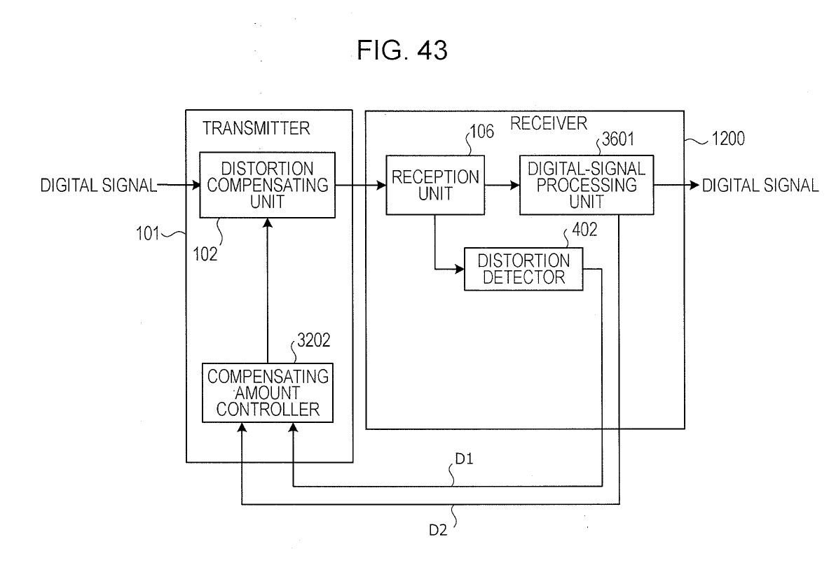

FIG. 43 illustrates a configuration of a nonlinear distortion compensation apparatus according to a twelfth embodiment. In the twelfth embodiment, deterioration of an error ratio of a reception reproduction signal is detected in digital signal processing, and when the error ratio becomes smaller than a predetermined threshold value, a distortion detection result is enabled.

In FIG. 43, a digital-signal processing unit 3601 which is connected to a receiving unit 106 reproduces a reception signal and performs certain processing such as parity check on a reproduction digital signal. When a result of the parity check is smaller than a predetermined threshold value, an ineffective signal D2 is output. A transmitter 101 includes, as with the tenth embodiment, a compensating-amount controller 3202. The compensating-amount controller 3202 receives a compensation signal D1 and an effective/ineffective signal D2. When receiving the ineffective signal D2, the compensating-amount controller 3202 outputs the ineffective compensation signal D1 which is a result of distortion detection and which is set to be ineffective to a distortion compensating unit 102. The compensating-amount controller 3202 may be included in a receiver 1200.

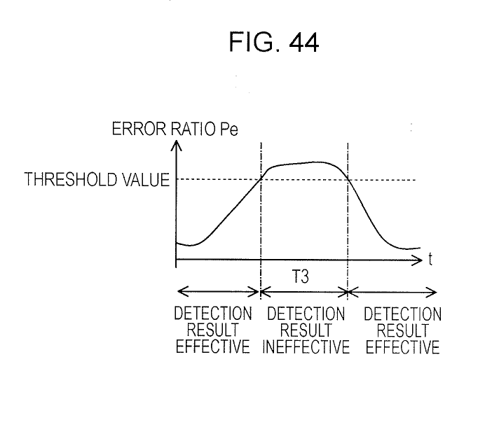

FIG. 44 illustrates an example of detection of an error ratio detected by the digital-signal processing unit 3601. An axis of abscissa denotes time and an axis of ordinate denotes the error ratio. A threshold value which is determined on the basis of a predetermined error ration Pe is set to the digital-signal processing unit 3601. While the error ratio is equal to or smaller than the threshold value, the digital-signal processing unit 3601 enables a distortion detection result. On the other hand, during a period T3 in which the error ratio is larger than the threshold value, the digital-signal processing unit 3601 disables the result of the distortion detection. The error ratio exceeds the threshold value when a level of identification of a reception signal point is deteriorated, and the distortion detection result can be disabled.

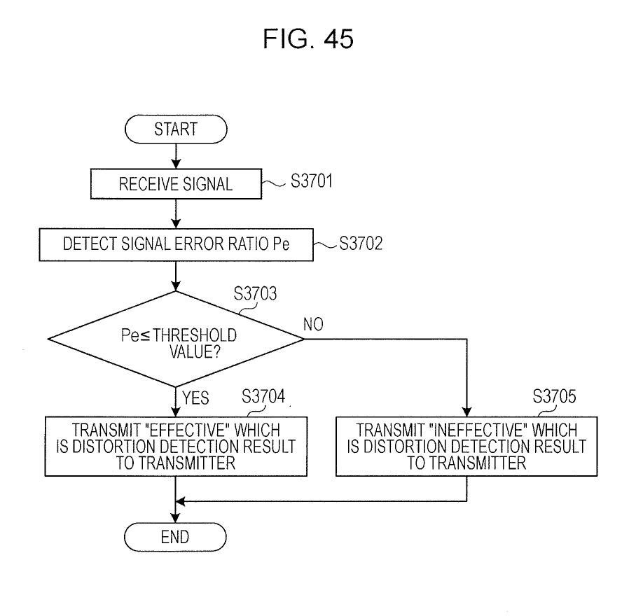

FIG. 45 illustrates a flowchart of processing for controlling distortion compensation according to the twelfth embodiment. Processing performed by the digital-signal processing unit 3601 is extracted and shown in FIG. 45. A receiving unit 106 receives a signal (in step S3701), and the digital-signal processing unit 3601 detects the error ratio Pe when a digital signal is reproduced (in step S3702). Then the error ratio Pe is compared with the threshold value. Specifically, when the error ratio Pe is equal to or smaller than the threshold value (“Yes” is selected in step S3703), an effective signal D2 representing an effective distortion detection result is transmitted to the transmitter 101 (in step S3704). On the other hand, when the error ratio Pe is larger than the threshold value (“No” is selected in step S3703), an ineffective signal D2 representing that the distortion detection result is ineffective is transmitted to the transmitter 101 (in step S3705).

With this configuration, when the error ratio at a time of reproduction of the reception signal is detected, a level of identification of the reception signal point is deteriorated, and it is determined that a distortion detection result obtained using signal points or passing coordinates at a time of movement among signal points includes an error, the distortion detection result is disabled. By this, influence of specific-signal movement detection using the reception signal which is misidentified can be eliminated, and deterioration of accuracy of compensation can be avoided.

### Thirteenth Embodiment

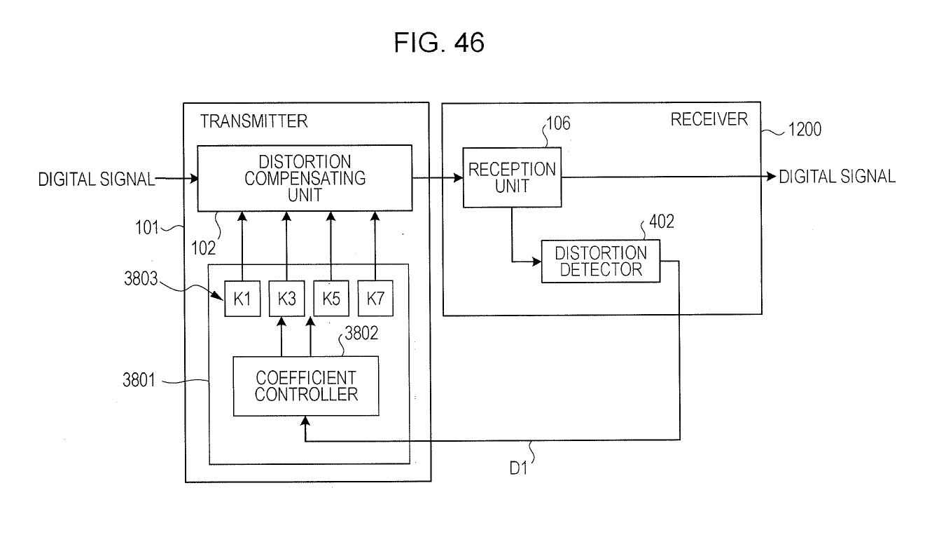

FIG. 46 illustrates a configuration of a nonlinear distortion compensation apparatus according to a thirteenth embodiment. In the thirteenth embodiment, when a distortion compensating unit 102 which performs distortion compensation on a signal output from an amplifying circuit 115 (refer to FIG. 2) included in a transmitter 101 is controlled in accordance with an expression, control processing is facilitated.

The transmitter 101 includes a coefficient setting unit 3801 which controls the distortion compensating unit 102 by setting a coefficient in accordance with an input compensation signal D1. The distortion compensating unit 102 approximates an input-output characteristic x of the amplifying circuit 115 by an approximate expression F(x)=K1·x+K3·x3+K5·x5+K7·x7 and performs distortion compensation in accordance with the approximate expression. The coefficient setting unit 3801 includes a coefficient controller 3802 and coefficient generators 3803. The coefficient generators 3803 transmit respective coefficients K1, K3, K5, and K7 to the distortion compensating unit 102. The coefficient controller 3802 controls coefficient setting for the coefficients K1, K3, K5, and K7 of the coefficient generators 3803 in accordance with an input compensation signal D1. The distortion compensating unit 102 performs distortion compensation suitable for a state of the amplifying circuit 115 in accordance with the set coefficients.

Then, among the coefficients K1, K3, K5, and K7 which constitute the input-output characteristic of the amplifying circuit 115 which has been subjected to mathematization, the high-order coefficients K5 and K7 which less affect change of the input-output characteristic are fixed to initial values, and the low-order coefficients K1 and K3 which considerably affect is variably controlled using the coefficient controller 3802. By this, complicated control of the distortion compensating unit 102 which controls a compensating amount in accordance with the expression can be avoided and distortion compensation can be controlled so as to be suitable for the state of the amplifying circuit 115.

With this configuration, in a case where the input-output characteristic of the amplifying circuit 115 is subjected to mathematization so that distortion compensation is controlled, the distortion compensation is easily controlled by assigning fixed values to the high-order coefficients K5 and K7 which less affect a compensating amount.

### Fourteenth Embodiment

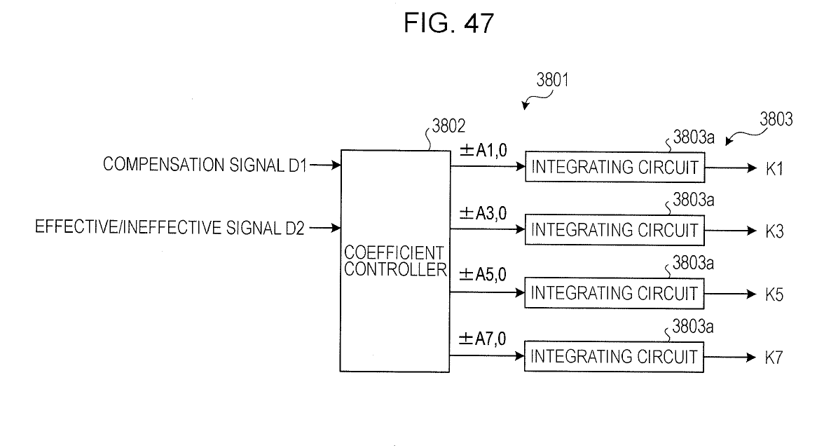

FIG. 47 illustrates a configuration of a nonlinear distortion compensation apparatus according to a fourteenth embodiment. In the fourteenth embodiment, when a distortion compensating unit 102 which performs distortion compensation on a signal output from an amplifying circuit 115 (refer to FIG. 2) included in a transmitter 101 is controlled in accordance with an expression, control processing is facilitated.

As with the thirteenth embodiment, a coefficient controller 3802 sets coefficients K1, K3, K5, and K7. The coefficient controller 3802 receives a compensation signal D1 which is a distortion detection result and an effective/ineffective signal D2 which has been described in the foregoing embodiments. In accordance with the compensation signal D1 and the effective/ineffective signal D2, the coefficient controller 3802 determines constants (A1, A3, A5, and A7) having appropriate changing amounts and changing directions (increase and decrease, i.e., plus and minus) for the corresponding coefficient in advance, and outputs them.

Then, in accordance with information representing an effective signal D2 or information representing an ineffective signal D2, the coefficient controller 3802 adds the constants A which have been weighted for individual coefficients to one another or subtracts the constants A from one another and outputs a result. The coefficients K1, K3, K5, and K7 are integrated by integrating circuits 3803a included in the coefficient generators 3803 and are output.

When the distortion compensating unit 102 performs approximation by the approximate expression F(x)=K1·x+K3·x3+K5·x5+K7·x7 so as to perform distortion compensation in accordance with the coefficients included in the approximate expression, appropriate changing amounts (A1, A3, A5, and A7) and changing directions (increase and decrease, i.e., plus and minus) are determined in advance for individual coefficients. When the ineffective signal D2 is transmitted, control is performed so as to add a value “0”. In the integrating circuits 3803a, appropriate initial values corresponding to the coefficients K1, K3, K5, and K7 are set. In this way, only by setting the appropriate initial values corresponding to the coefficients K1, K3, K5, and K7 in the integrating circuits 3803a, by instructing the coefficient controller 3802 to perform uniform addition (+) or uniform subtraction (−) to be performed on the constants A1, A3, A5, and A7 to which magnitude and polarity±corresponding to the coefficients K1, K3, K5, and K7 are set, and by controlling the addition of a value “0” when the ineffective signal D2 is transmitted, the distortion compensating unit 102 can be easily controlled. Alternatively, the distortion compensating unit 102 can be controlled only using a distortion detection result of one bit represented by the compensation signal D1 and a signal of one bit representing “effective”/“ineffective” of the distortion detection result represented by the effective/ineffective signal D2.

With the configuration described above, when the input-output characteristic of the amplifying circuit 115 is subjected to mathematization so that distortion compensation control is performed, the coefficients constituting the input-output characteristic of the amplifying circuit 115 which has been mathematization can be easily updated, and the distortion compensating unit 102 can be easily controlled.

### Fifteenth Embodiment

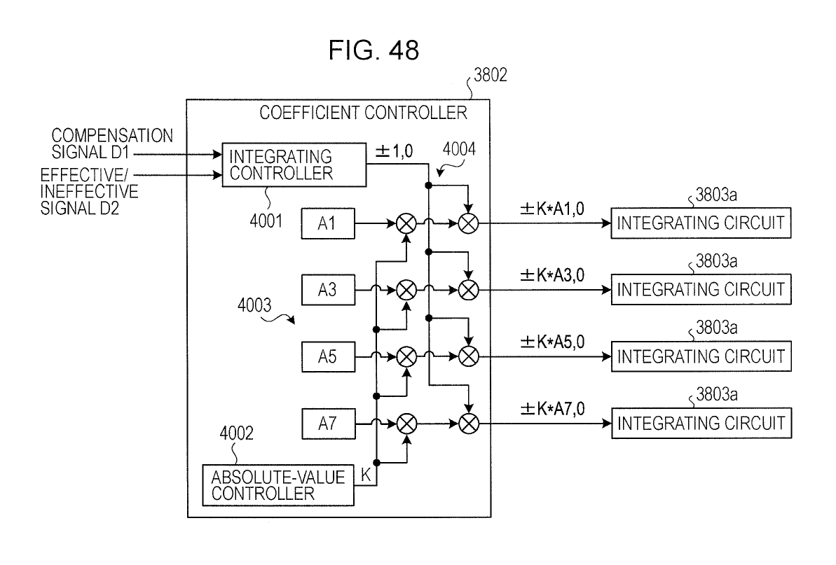

FIG. 48 illustrates a configuration of a nonlinear distortion compensation apparatus according to a fifteenth embodiment. In the fifteenth embodiment, when a distortion compensating unit 102 which performs distortion compensation on a signal output from an amplifying circuit 115 (refer to FIG. 2) included in a transmitter 101 is controlled in accordance with an expression, following capability and stability for changing of a distortion amount are attained.

A coefficient controller 3802 which is similar to that described in the fourteenth embodiment includes an integrating controller 4001 which performs control of addition/subtraction or addition using a value “0” in integrating circuits 3803a, an absolute-value controller 4002 which controls absolute values of constants A1, A3, A5, and A7 which are to be input in the integrating circuits 3803a in accordance with an input compensation signal D1 and an input effective/ineffective signal D2, and multipliers 4004 which multiply the constants A1, A3, A5, and A7 which have been set by constant setting units 4003 by an absolute-value control signal output from the absolute-value controller 4002 and which multiply the constants A1, A3, A5, and A7 by an integrating control signal output from the integrating controller 4001.

Each of the constants A1, A3, A5, and A7 has positive or negative polarity. In accordance with a control signal output from the absolute-value controller 4002, magnitudes of the absolute values of the constants A1, A3, A5, and A7 are controlled at a uniform ratio. Constants A1a, A3a, A5a, and A1a obtained after controlling the absolute values of the constants A1, A3, A5, and A7 are multiplied by a control signal of ±1 and 0 supplied from the integrating controller 4001 and are supplied to the corresponding integrating circuits 3803a.

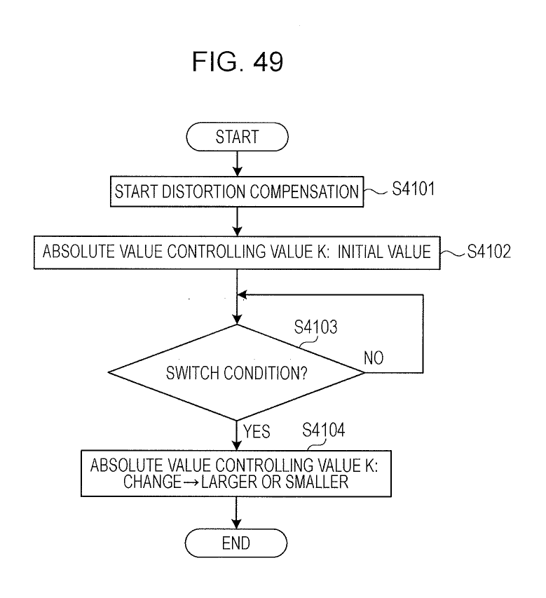

FIG. 49 illustrates a flowchart of processing for controlling distortion compensation according to the fifteenth embodiment. Processing performed by the coefficient controller 3802 is extracted and shown in FIG. 49. When distortion compensation is started (in step S4101), first, the absolute-value controller 4002 outputs an absolute value as an initial value K (in step S4102). Thereafter, it is determined whether a condition is to be changed (in step S4103). Here, as is described in the seventh embodiment, the distortion compensating unit 102 does not change the condition until a predetermined period of time has passed or while a control loop is not converged (the process proceeds to “No” and enters a loop in step S4103). On the other hand, the distortion compensating unit 102 changes the condition after the predetermined period of time or after the control loop is converged (“Yes” is selected in step S4103).

In this way, the absolute value to which the initial value is assigned is changed to be increased or reduced (in step S4104). When a changing amount of a control signal is to become large, the absolute values of the constants A1, A3, A5, and A7 are increased. On the other hand, the absolute values of the constants A1, A3, A5, and A7 are reduced so that the changing amount of the control signal is reduced in order to attain stable operation. In this way, weighting of the constants is changed depending on a condition.

With this configuration, in a distortion compensation circuit which controls the coefficients by performing addition or subtraction on the constants which have been weighted for individual coefficients, when a large change of a compensating amount is required, appropriate constants are selected so that control speed is prioritized whereas when stability of the compensating amount is required, appropriate constants are selected so that the control stability is prioritized. In this way, following capability and stability for changing of a distortion amount are attained.

### Sixteenth Embodiment

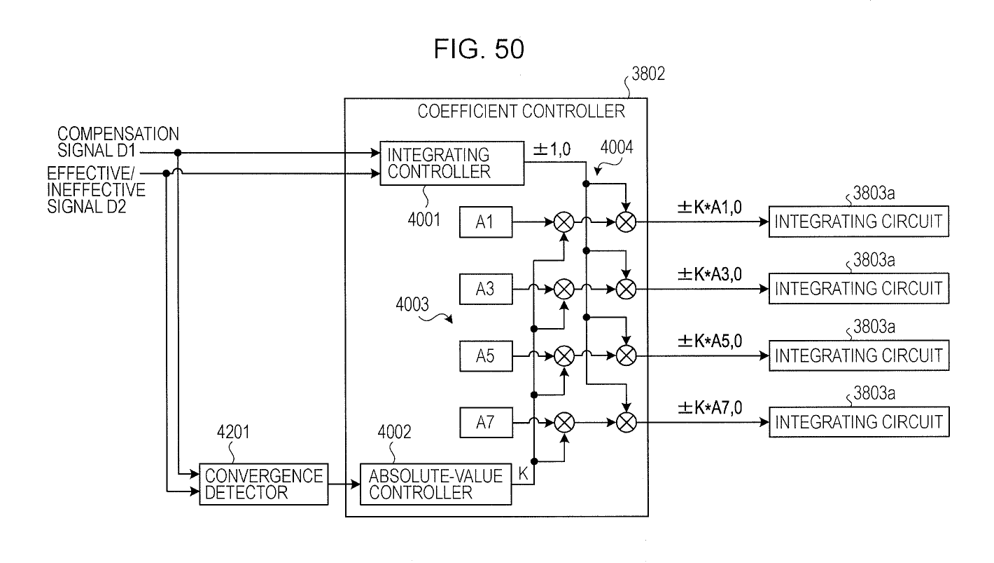

FIG. 50 illustrates a configuration of a nonlinear distortion compensation apparatus according to a sixteenth embodiment. The sixteenth embodiment which is a modification of the fifteenth embodiment detects convergence of a control loop and attains stable changing of constants before convergence to constants after convergence by changing absolute values of the constants in accordance with a result of the detection of the convergence.

In a configuration shown in FIG. 50, a compensation signal D1 and an effective/ineffective signal D2 are also supplied to a convergence detector 4201. The convergence detector 4201 detects the convergence of the control loop in accordance with a result of a determination as to whether distortion has occurred using the compensation signal D1 and the effective/ineffective signal D2 and controls an absolute-value controller 4002. Each of the constants A1, A3, A5, and A7 has positive or negative polarity. In accordance with a control signal output from the absolute-value controller 4002, magnitudes of the absolute values of the constants A1, A3, A5, and A7 are controlled at a uniform ratio. Constants A1a, A3a, A5a, and A7a obtained after controlling the absolute values of the constants A1, A3, A5, and A7 are multiplied by a control signal of ±1 and 0 supplied from the integrating controller 4001 and are supplied to the corresponding integrating circuits 3803a.

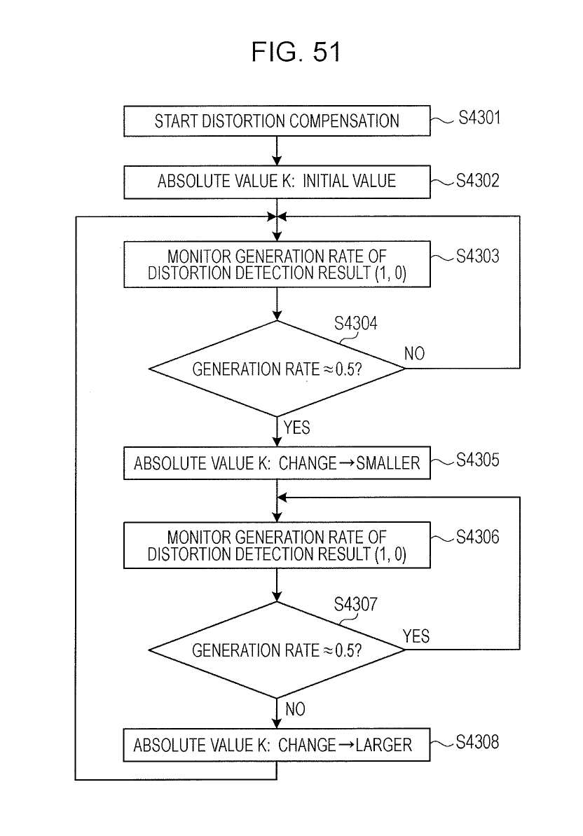

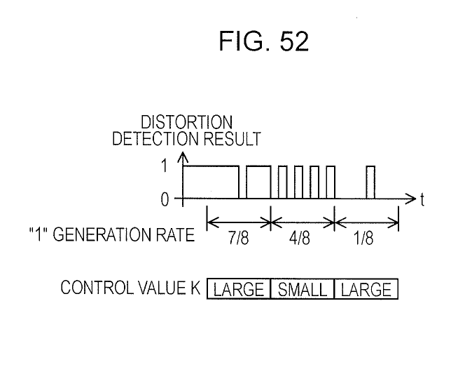

FIG. 51 illustrates a flowchart of processing for controlling distortion compensation according to the sixteenth embodiment. FIG. 52 illustrates a state of generation of distortion detection results. An axis of abscissa denotes time and an axis of ordinate denotes a distortion detection result (compensation signal D1). A value “1” of the distortion detection result (compensation signal D1) represents that the result is larger than a reference value, that is, distortion is not detected or overcompensation whereas a value “0” represents that the result is smaller than the reference value, that is, distortion is generated.

When distortion compensation is started (in step S4301), the absolute-value controller 4002 outputs an absolute value as an initial value K (in step S4302). Thereafter, the convergence detector 4201 monitors a ratio of generation (appearance ratio) of the distortion detection result “1, 0” (in step S4303). As shown in FIG. 52, for example, in a first stage, the value “1” frequently appears as the value of the distortion detection result (compensation signal D1).

The convergence detector 4201 monitors until the ratio of generation of the distortion detection result “1, 0” is close to 50% (the process proceeds to “No” and enters a loop in step S4304). When the generation ratio is close to 50% (“Yes” is selected in step S4304) as shown in FIG. 52, since the control loop is converged, the convergence detector 4201 transmits convergence information to the absolute-value controller 4002. The absolute-value controller 4002 changes the absolute values of the constants A1, A3, A5, and A7 to be small in accordance with the convergence information (in step S4305). Accordingly, high accuracy of a distortion compensating amount is attained.

Thereafter, the convergence detector 4201 continues to monitor the ratio of generation of the distortion detection result “1, 0” (proceeds to “Yes” and enters a loop in step S4306 and step S4307). When the generation ratio is out of 50% again as shown in FIG. 52 (“No” is selected in step S4307), an appropriate distortion compensating amount is not obtained due to change of a state of an amplifying circuit 115 after the convergence of the control loop, and the generation ratio of the values “1” and “0” of the distortion detection result is not balanced. Therefore, the absolute values of the constants A1, A3, A5, and A7 are increased (in step S4308). Thereafter, the process returns to step S4303 and the control is continued.

With this configuration, after the distortion compensation is started, the absolute values of the constants A1, A3, A5, and A7 are reduced so that the ratio of generation of the distortion detection result “1, 0” of 50% is attained. In this way, high accuracy of the distortion compensating amount and convergence of the control loop is attained. Furthermore, even after convergence of the control loop, if the distortion compensating amount becomes inappropriate due to change of the state of the amplifying circuit, for example, deviation of the ratio of generation of the distortion detection results “1” and “0” is monitored, and the absolute values of the constants A1, A3, A5, and A7 are made larger. By this, the inappropriate distortion compensating amount is changed to an appropriate distortion compensating amount. As described above, in the distortion compensating circuit which controls the coefficients by addition or subtraction of the coefficients which have been weighted for individual coefficients, the absolute values of the constants to be subjected to addition or subtraction can be changed, the convergence of the control loop is detected, and the absolute values of the constants can be changed in accordance with the result of the detection of convergence. In this way, change of the constants before or after convergence can be made stable.

According to the nonlinear distortion compensating apparatus and the method for compensating for nonlinear distortion described above, nonlinear distortion compensation can be easily controlled with high accuracy, and therefore, quality of wireless communication may be improved.

Furthermore, according to the nonlinear distortion compensating apparatus and the method for compensating for nonlinear distortion described above, in a digital wireless communication, nonlinear distortion can be detected from a reception signal received by a receiver, information on the detected nonlinear distortion can be transmitted to a transmitter, and the transmitter can perform distortion compensation. Accordingly, nonlinear distortion generated in an amplifying circuit included in the transmitter can be cancelled in the transmitter serving as a transmission source. Consequently, communication quality may improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A nonlinear distortion compensating apparatus comprising:
a distortion detector configured to detect nonlinear distortion by reproducing a reception signal and output information on the detected nonlinear distortion as control information to a distortion compensating unit which compensates for the nonlinear distortion and which is included in a transmitter.

2. The nonlinear distortion compensating apparatus according to claim 1,
wherein the distortion detector includes an input-output characteristic changing unit which obtains an input-output characteristic of an amplifying circuit included in the transmitter on a basis of a correlation between passing coordinates which are detected when the reception signal is reproduced and which are obtained when the reception signal moves among signal points and signal-point coordinates serving as reference coordinates, and which outputs the input-output characteristic as a compensation signal to the distortion compensating unit.

3. The nonlinear distortion compensating apparatus according to claim 1,
wherein the distortion detector includes
a reference value generating unit configured to calculate reference coordinates to be passed which are located among signal points and which are restricted by signal points to be passed,
a passing coordinate extracting unit configured to extract passing coordinates detected when the reception signal is reproduced, and
a comparing unit configured to output a result of distortion detection obtained by comparison between the reference coordinates and the passing coordinates as a compensation signal to the distortion compensating unit.

4. The nonlinear distortion compensating apparatus according to claim 3,
wherein the reference value generating unit includes a digital filter serving as a band-limitation filter included in the transmitter, and obtains outputs of the digital filter as the reference coordinates.

5. The nonlinear distortion compensating apparatus according to claim 3,
wherein the reception signal to be input to the reference value generating unit has been subjected to waveform equalization, interference compensation, and error correction.

6. The nonlinear distortion compensating apparatus according to claim 2 further comprising:
a specific-signal movement detector configured to detect movement of the reception signal among specific signal points,
wherein the specific-signal movement detector supplies an effective signal which enables a distortion detection result of the compensation signal when the movement among specific signal points is detected to the distortion compensating unit.

7. The nonlinear distortion compensating apparatus according to claim 6,
wherein the specific-signal movement detector has a plurality of patterns of numbers of signal points which are used to detect the movement among the specific signal points, and switches one of the patterns to another using a switching unit depending on a condition.

8. The nonlinear distortion compensating apparatus according to claim 7,
wherein the switching unit is included in the transmitter.

9. The nonlinear distortion compensating apparatus according to claim 6,
wherein the specific-signal movement detector includes
a first specific-signal movement condition detector configured to detect a first specific-signal movement condition suitable for convergence of a control loop, and
a second specific-signal movement condition detector configured to detect a second specific-signal movement condition suitable for attaining high accuracy of distortion compensation.

10. The nonlinear distortion compensating apparatus according to claim 9,
wherein the second specific-signal movement condition includes the first specific-signal movement condition.

11. The nonlinear distortion compensating apparatus according to claim 3, further comprising:
a signal-point error detector configured to detect differences between signal-point coordinates of the reception signal and regular signal-point coordinates, and output an ineffective signal which disables a distortion detection result of the compensation signal when the differences are larger than a predetermined threshold value.

12. The nonlinear distortion compensating apparatus according to claim 3, further comprising:
a reception-level deterioration detector configured to output an ineffective signal which disables a distortion detection result of the compensation signal to the distortion compensating unit when reception power of the reception signal becomes smaller than a predetermined threshold value.

13. The nonlinear distortion compensating apparatus according to claim 3, further comprising:
a digital-signal processing unit configured to output an ineffective signal which disables a distortion detection result of the compensation signal to the distortion compensating unit when deterioration of a signal error ratio obtained when the reception signal is output as a digital signal is detected.

14. The nonlinear distortion compensating apparatus according to claim 1,
wherein the distortion compensating unit includes a coefficient setting unit configured to, when nonlinear distortion is compensated for using a predetermined approximate expression representing an input-output characteristic of an amplifying circuit, fix coefficients to be initial values, which less affect change of a compensating amount among a plurality of coefficients included in the approximate expression, perform control so that coefficients which considerably affect are variable in accordance with a compensation signal, and output the coefficients to the distortion compensating unit.

15. The nonlinear distortion compensating apparatus according to claim 14,
wherein the coefficient setting unit changes the coefficients using weighted constants in accordance with a distortion detection result represented by the compensation signal.

16. The nonlinear distortion compensating apparatus according to claim 15,
wherein the coefficient setting unit changes weighting of the constants in accordance with the distortion detection result represented by the compensation signal.

17. The nonlinear distortion compensating apparatus according to claim 16, further comprising:
a convergence detector configured to detect convergence of processing for controlling nonlinear distortion compensation performed by the distortion compensating unit,
wherein the coefficient setting unit changes weighting of the constants in accordance with a state of the convergence detected by the convergence detector.

18. A nonlinear distortion compensating method comprising:
distortion detection processing for detecting nonlinear distortion by reproducing a reception signal and outputting information on the detected nonlinear distortion as control information to a distortion compensating unit which compensates for the nonlinear distortion and which is included in a transmitter.

19. The nonlinear distortion compensating method according to claim 18,
wherein the distortion detection processing includes an input-output characteristic changing processing for obtaining an input-output characteristic of an amplifying circuit included in the transmitter on the basis of the correlation between passing coordinates which are detected when the reception signal is reproduced and which are obtained when the reception signal moves among signal points and signal-point coordinates serving as reference coordinates, and for outputting the input-output characteristic as a compensation signal to the distortion compensating unit.

20. The nonlinear distortion compensating method according to claim 18,
wherein the distortion detection processing includes
reference value generation processing for calculating reference coordinates to be passed which are located among signal points and which are restricted by signal points to be passed,
passing coordinate extraction processing for extracting passing coordinates detected when the reception signal is reproduced, and
comparison processing for outputting a result of distortion detection obtained by comparison between the reference coordinates with the passing coordinates as a compensation signal to the distortion compensating unit.
